(19) United States
(12) Patent Application Publication
(10) Pub. No.: US 2010/0138271 A1
(43) Pub. Date: Jun. 3, 2010

(54) Techniques for facilitating on-line contextual analysis and advertising

(75) Inventors: Assaf Henkin, San Francisco, CA (US); Yoav Shaham, San Francisco, CA (US); Itai Brickner, San Francisco, CA (US); Trond Grenager, San Francisco, CA (US); Daniel Klein, Alameda, CA (US)

Correspondence Address: SCHWEGMAN, LUNDBERG & WOESSNER, P.A., P.O. BOX 2938, MINNEAPOLIS, MN, 55402, US

(73) Assignee: Kontera Technologies, Inc.

(21) Appl. No.: 11/891,437

(22) Filed: Aug. 10, 2007

Related U.S. Application Data
(63) Continuation of application No. 11/732,694, filed on Apr. 3, 2007.
(60) Provisional application No. 60/789,009, filed on Apr. 3, 2006.
(60) Provisional application No. 60/789,010, filed on Apr. 3, 2006.
(60) Provisional application No. 60/799,067, filed on May 8, 2006.
(60) Provisional application No. 60/797,117, filed on May 2, 2006.
(60) Provisional application No. 60/797,250, filed on May 2, 2006.
(60) Provisional application No. 60/836,473, filed on Aug. 8, 2006.

(51) Int. Cl. G06Q 30/00; G06F 17/30

(52) U.S. Cl. 705/10

(57) ABSTRACT

Various techniques are disclosed for facilitating on-line contextual analysis and/or advertising operations implemented in a computer network. According to some embodiments, various aspects may be used for enabling advertisers to provide contextual advertising promotions to end-users based upon real-time analysis of web page content which may be served to an end-user's computer system. In at least one embodiment, the information obtained from the real-time analysis may be used to select, in real-time, contextually relevant information, advertisements, and/or other content which may then be displayed to the end-user, for example, via real-time insertion of textual markup objects and/or dynamic content. According to specific embodiments, various operations may be performed for adapting or modifying a conventional context-based advertising systems to improve various features such as, for example, ad relevance estimation, click-through rate estimation, advertisement selection and layout, balancing exploration and exploitation, etc.

### RELATED APPLICATION DATA

This application is a continuation of, and claims priority under 35 U.S.C. §120 to prior U.S. patent application Ser. No. 11/732,694 (Attorney Docket No. KABAP011B) entitled “TECHNIQUES FOR FACILITATING ON-LINE CONTEXTUAL ANALYSIS AND ADVERTISING” by Henkin et al., filed on Apr. 3, 2007, which claims benefit under 35 U.S.C. §119 to: U.S. Provisional Application Ser. No. 60/789,009 (Attorney Docket No. KABAP005P), entitled, “KEYWORD TAXONOMY FOR FACILITATING CONTEXTUAL ANALYSIS OF DOCUMENT CONTENT,” naming Henkin et al. as inventors, filed Apr. 3, 2006; and to U.S. Provisional Application Ser. No. 60/789,010 (Attorney Docket No. KABAP006P), entitled, “TECHNIQUE FOR DETERMINING AND DISPLAYING RELATED LINKS BASED UPON KEYWORDS,” naming Henkin et al. as inventors, filed Apr. 3, 2006; and to U.S. Provisional Application Ser. No. 60/799,067 (Attorney Docket No. KABAP007P), entitled, “ADVERTISEMENT SELECTION TECHNIQUE BASED ON CONTEXTUAL ANALYSIS OF DOCUMENT CONTENT,” naming Henkin et al. as inventors, filed May 8, 2006; and to U.S. Provisional Application Ser. No. 60/797,117 (Attorney Docket No. KABAP008P), entitled, “TECHNIQUES FOR FACILITATING TOPIC EXPANSION AND AUTOMATED LEARNING/OPTIMIZATION OF TOPIC SELECTION IN ADVERTISING ENVIRONMENT,” naming Henkin et al. as inventors, filed May 2, 2006; and to U.S. Provisional Application Ser. No. 60/797,250 (Attorney Docket No. KABAP009P), entitled, “PAGE CONTEXT ADVERTISEMENT SELECTION TECHNIQUE,” naming Henkin et al. as inventors, filed May 2, 2006; and to U.S. Provisional Application Ser. No. 60/836,473 (Attorney Docket No. KABAP011P), entitled, “SYSTEMS AND METHODS FOR ON-LINE CONTEXTUAL ANALYSIS AND ADVERTISING,” naming Henkin et al. as inventors, and filed Aug. 8, 2006. Each of these applications is incorporated herein by reference in its entirety for all purposes.

### BACKGROUND OF THE INVENTION

Over the past decade the Internet has rapidly become an important source of information for individuals and businesses. The popularity of the Internet as an information source is due, in part, to the vast amount of available information that can be downloaded by almost anyone having access to a computer and a modem. Moreover, the internet is especially conducive to conduct electronic commerce, and has already proven to provide substantial benefits to both businesses and consumers.

Many web services have been developed through which vendors can advertise and sell products directly to potential clients who access their websites. To attract potential consumers to their websites, however, like any other business, requires target advertising. One of the most common and conventional advertising techniques applied on the Internet is to provide advertising promotions (e.g., banner ads, pop-ups, ad links) on the web page of another website which directs the end user to the advertiser's site when the advertising promotion is selected by the end user. Typically, the advertiser selects websites which provide context or services related to the advertiser's business.

Conventionally, the process of adding contextual advertising promotions to web page content is both resource intensive and time intensive. In recent years the process has been somewhat automated by utilizing software applications such as application servers, ad servers, code editors, etc. Despite such advances, however, the fact remains that conventional contextual advertising techniques typically require substantial investments in qualified personnel, software applications, hardware, and time.

Furthermore, conventional on-line marketing and advertising techniques are often limited in their ability to provide contextually relevant material for different types of web pages.

As access to the Internet becomes more available, there is a greater potential to gather data relating to user behaviors and activities, and to present contextually relevant advertisements to different markets of people who are able to access the Internet.

### SUMMARY

Various aspects are directed to different methods, systems, and computer program products for facilitating on-line contextual advertising operations implemented in a computer network. According to some embodiments, various aspects may be used for enabling advertisers to provide contextual advertising promotions to end-users based upon real-time analysis of web page content which may be served to an end-user's computer system. In at least one embodiment, the information obtained from the real-time analysis may be used to select, in real-time, contextually relevant information, advertisements, and/or other content which may then be displayed to the end-user, for example, via real-time insertion of textual markup objects and/or dynamic content.

Other aspects are directed to different methods, systems, and computer program products for facilitating on-line contextual analysis and/or advertising operations implemented in a computer network. In at least one embodiment, an estimation engine may be utilized which is operable to generate expected monetary value (EMV) information relating to estimates of Expected Monitory Values (EMVs) based on specified criteria. In one embodiment, the specified criteria may include click through rate (CTR) estimation information. In at least one embodiment, a relevance engine may be utilized which is operable to generate relevance information relating to relevance criteria between a specified page or document and at least one specified ad. In at least one embodiment, a layout engine may be utilized which is operable to generate ad ranking information for one or more of the at least one specified ads using the relevance information and EMV information. In at least one embodiment, a data analysis engine may be utilized which is operable to analyze historical information including user behavior information and advertising-related information. In at least one embodiment, an exploration engine may be utilized which is operable to explore the use of selected keywords and ads in order for the purpose of improving EMV estimation.

Other aspects are directed to different methods, systems, and computer program products for facilitating on-line contextual analysis and/or advertising operations implemented in a computer network. According to at least one embodiment, a first page may be identified for contextual ad analysis. Page classifier data may be generated, for example, using content associated with the first page. In at least one embodiment, a first group of keywords on the page may be identified as being candidates for ad markup/highlighting. In at least one embodiment, one or more potential ads may be identified for selected keywords of the first group of keywords. In at least one embodiment, ad classifier data may be generated for each of the identified ads using at least one of: ad content, meta data, and/or content of the ad's landing URL. In at least one embodiment, a relevance score may be generated for each of the selected ads. In one embodiment, the relevance score may indicate the degree of relevance between a given ad and the content of the identified page. In at least one embodiment, a ranking value may be generated for each selected ad based on the ad's associated relevance score and associated EVM estimate. In at least one embodiment, specific keywords may be selected for markup/highlighting using at least the ad ranking values.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 shows a block diagram of a computer network portion 100 which may be used for implementing various aspects of the present invention in accordance with a specific embodiment.

FIG. 2 shows a block diagram of various components and systems of a Kontera Server System 200 which may be used for implementing various aspects of the present invention in accordance with a specific embodiment.

FIG. 3A shows a flow diagram illustrating various information flows and processes of the present invention which may occur at various systems in accordance with a specific embodiment.

FIG. 3B shows an alternate embodiment of flow diagram illustrating various information flows and processes which may occur at various systems in accordance with a specific embodiment.

FIGS. 4A-G provide examples of various screen shots which illustrate different techniques which may be used for modifying web page displays in order to present additional contextual advertising information.

FIG. 5A shows an example of a taxonomy structure 500 in accordance with a specific embodiment.

FIG. 5B shows an example of a keyword taxonomy database record 530 in accordance with a specific embodiment.

FIG. 5C shows a block diagram representing a specific embodiment of portion of taxonomy information 557 which, for example, may be stored in a taxonomy database.

FIG. 5D shows a block diagram of a specific embodiment graphically illustrating various data flows which may occur during selection of one or more keywords and/or topics.

FIGS. 5E and 5F illustrate examples of portions of dynamic node taxonomy data structure in accordance with a specific embodiment.

FIG. 6 shows a flow diagram of an ContentLink Selection Procedure 600 in accordance with a specific embodiment.

FIG. 7 shows an example of a web page 701 which may be used for illustrating various aspects of one or more techniques described herein.

FIG. 8 shows a flow diagram of a Topic Expansion/Self Learning Procedure 800 in accordance with a specific embodiment.

FIG. 9 shows an example of a cache entry for a webpage in accordance with a specific embodiment.

FIG. 10A illustrates an example of one embodiment which may be used for obtaining one or more ad candidates.

FIG. 10B shows an example of various types of information which may be included with an ad candidate.

FIG. 11 shows a flow diagram of an Ad Selection Analysis Procedure 1100 in accordance with a specific embodiment.

FIG. 12A shows a block diagram of a portion of a Kontera Server System 1200 in accordance with a specific embodiment.

FIG. 12B shows a high level architecture of a specific embodiment of an on-line contextual advertising system in accordance with a specific embodiment.

FIGS. 13A-D depict graphical representations illustrating various behaviors associated with different types of distance scoring functions.

FIG. 14 shows an example of a portion of pseudocode 1400 representing a page layout algorithm.

FIG. 15 shows a flow diagram of a Keyword Selection Procedure 1500 in accordance with a specific embodiment.

FIG. 16 provides a specific example of various criteria which may be used and/or generated during embodiment of the Keyword Selection Procedure 1500 and FIG. 15.

FIG. 17 shows a specific embodiment of a network device 60 suitable for implementing at least a portion of the contextual information analysis and delivery techniques described herein.

### DETAILED DESCRIPTION OF THE PREFERRED EMBODIMENTS

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Aspects of the present invention relate to systems and methods for real-time web page context analysis and real-time insertion of textual markup objects and dynamic content. According to various embodiments of the present invention, real-time web page context analysis and/or real-time insertion of textual markup objects and dynamic content may occur in real-time (or near real-time), for example, as part of the process of serving, retrieving and/or rendering a requested web page for display to a user. In other embodiments of the present invention, web page context analysis and/or insertion of textual markup objects and dynamic content may occur in non real-time such as, for example, in at least a portion of situations where selected web pages are periodically analyzed off-line, modified in accordance with one or more aspects of the present invention, and served to a number of users over a period of time with the same highlighted keywords, ads, etc.

According to an example embodiment, aspects of the present invention may be used for enabling advertisers to provide contextual advertising promotions to end-users based upon real-time analysis of web page content that is being served to the end-user's computer system. In at least one embodiment, the information obtained from the real-time analysis may be used to select, in real-time, contextually relevant information, advertisements, and/or other content which may then be displayed to the end-user, for example, via real-time insertion of textual markup objects and/or dynamic content.

According to different embodiments of the present invention, a variety of different techniques may be used for displaying the textual markup information and/or dynamic content information to the end-user. Such techniques may include, for example, placing additional links to information (e.g., content, marketing opportunities, promotions, graphics, commerce opportunities, etc.) within the existing text of the web page content by transforming existing text into hyperlinks; placing additional relevant search listings or search ads next to the relevant web page content; placing relevant marketing opportunities, promotions, graphics, commerce opportunities, etc. next to the web page content; placing relevant content, marketing opportunities, promotions, graphics, commerce opportunities, etc. on top or under the current page; finding pages that relate to each other (e.g., by relevant topic or theme), then finding relevant keywords on those pages, and then transforming those relevant keywords into hyperlinks that link between the related pages; etc.

The following disclosure describes various embodiments for increasing revenue potential which may be generated via on-line contextual advertising techniques such as those employing contextual in-text keyword advertising techniques for displaying advertisements to end users of computer systems.

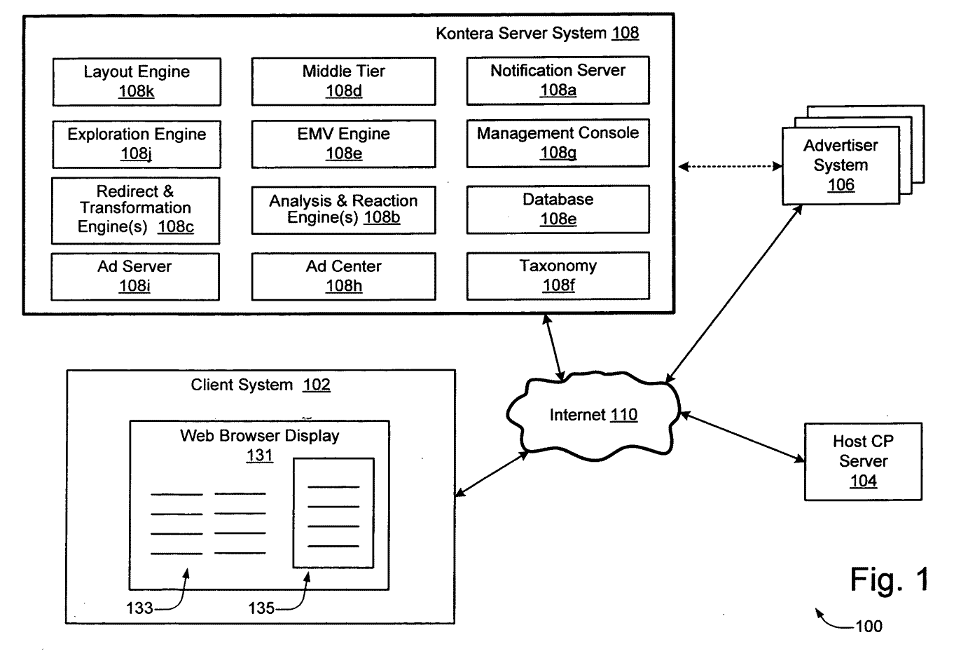

FIG. 1 shows a block diagram of a computer network portion 100 which may be used for implementing various aspects of the present invention in accordance with a specific embodiment. As illustrated in FIG. 1, network portion 100 includes at least one client system 102, at least one host server or content provider (CP) server 104, at least one advertiser system 106, and at least one contextual analysis and response server (herein referred to as “Kontera Server System” or “Kontera Server”) 108.

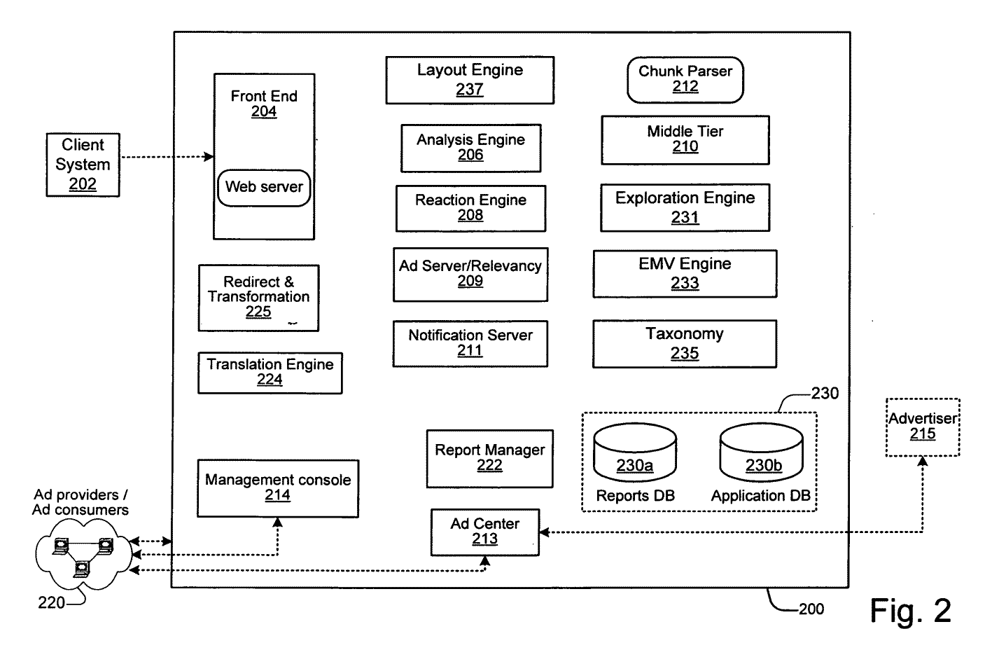

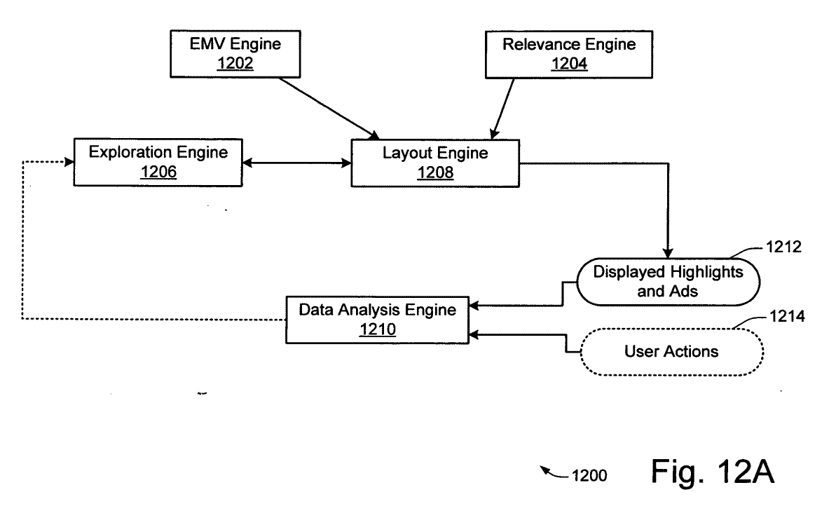

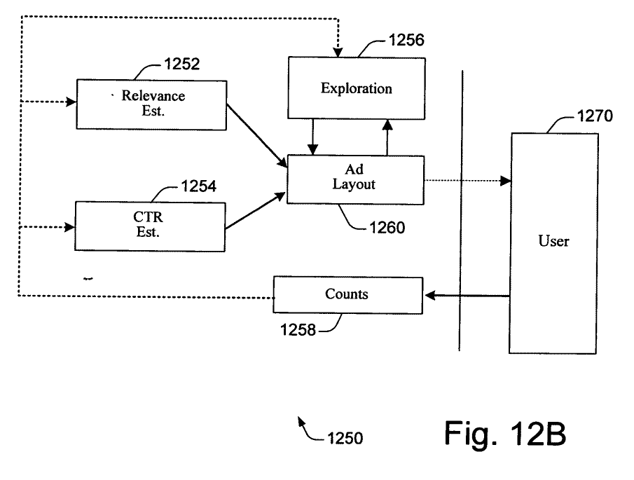

In at least one embodiment, the Kontera Server System 108 may be configured or designed to implement various aspects of the present invention including, for example, real-time web page context analysis and/or real-time insertion of textual markup objects and dynamic content. In the example of FIG. 1, the Kontera Server System 108 is shown to include one or more of the following components: an Ad Server module 108i, a Notification Server 108a, Analysis & Reaction Engine(s) 108b, Redirect & Transformation Engine(s) 108c, a Middle Tier component 108d, a database 108e, a Taxonomy component 108f, a Management Console 108g, an Ad Center component 108h, an Exploration Engine 108j, a Layout Engine 108k, an EMV (Estimated Monetary Value) Engine 108m, etc. It will be appreciated that other embodiments may include fewer, different and/or additional components than those illustrated in FIG. 1. A number of these components are described in greater detail below (such as, for example, with reference to FIGS. 2, 12A, and 12B of the drawings).

In example embodiments, the client system 102 may include a Web browser display 131 adapted to display content 133 (e.g., text, graphics, links, frames 135, etc.) relating desired web pages, file systems, documents, advertisements, etc.

It will be appreciated that other embodiments may include fewer, different and/or additional components than those illustrated in FIG. 1.

In one embodiment, such analysis and/or calculations may be implemented in real-time (or near real-time) in order allow one technique(s) described herein to automatically and dynamically adapt, in real-time, its algorithms and/or other mechanisms for selecting and/or estimating potential revenue relating to on-line contextual advertising techniques such as those employing contextual in-text keyword advertising.

Additionally, in some example embodiments, aspects of the present invention may be applied to real-time advertising in situations where selected keywords (KWs) are not located in the content of the page or document. For example, referring to FIG. 1, various techniques according to embodiments of the present invention may be applied to content (e.g., 133) in the main body of a web page and/or to content in frames such as, for example, Ad Frame portion 135, which, for example, may be used for displaying advertisements (or other information) that is not included as part of the original content of the web page. Moreover, these techniques may also be used to analyze dynamically generated content such as, for example, content of a web page which dynamically changes with each refresh of the URL. In at least one embodiment, it is also possible to display ads directly based on keywords and/or topics identified in the Ad Frame portion 135. In one example embodiment, performance of a keyword may be based, at least in part, on how many clicks are generated for the associated ad.

For purposes of illustration, an exemplary embodiment of FIG. 1 will be described for the purpose of providing an overview of how various components of the computer network portion 100 may interact with each other. In this example, it is assumed at that a user at the client system 102 has initiated a URL request to view a particular web page such as, for example, www.yahoo.com. Such a request may be initiated, for example, via the Internet using an Internet browser application at the client system. According to a specific embodiment, when the URL request is received at the content provider server 104, server 104 responds by transmitting the URL request info and/or web page content (corresponding to the requested URL) to the Kontera Server System 108. In a specific embodiment where the Kontera Server System receives only the URL request information from the content provider server, the Kontera Server System may request the web page content (corresponding to the requested URL) from the content provider server 104. The server 104 may then respond by providing the requested web page content to the Kontera Server System.

According to specific embodiments, as the Kontera Server System 108 receives the web page content from the content provider server 104, it analyzes, in real-time, the received web page content (and/or other information) in order to generate page information (e.g., page classifier data) and keyword information (e.g., list identified keywords on page which may be suitable for highlight/mark-up). The keyword information may then be used to retrieve or identify one or more ad candidates from advertisers (e.g., Advertiser System 106). In one embodiment, each ad candidate may include one or more of the following: title information relating to the ad; a description or other content relating to the ad; a click URL that may be accessed when the user clicks on the ad; a landing URL which the user will eventually be redirected to after the click URL action has been processed; cost-per-click (CPC) information relating to one or more monetary values which the advertiser will pay for each user click on the ad; etc.

According to a specific embodiment, it is possible for the Kontera Server System 108 to receive different contextual ad information from a plurality of different advertiser systems. In one embodiment, the received ad information (and/or other information associated therewith) may be analyzed and processed to generate relevance information, estimated value information, etc. The identified ad candidates may then be ranked, and specific ads selected based on predetermined criteria. Once a desired ad has been selected, the Kontera Server System may then generate web page modification instructions for use in generating contextual in-text keyword advertising for one or more selected keywords of the web page.

According to a specific embodiment, the web page modification operations may be implemented automatically, in real-time, and without significant delay. As a result, such modifications may be performed transparently to the user. Thus, for example, from the user's perspective, when the user requests a particular web page to be retrieved and displayed on the client system, the client system will respond by displaying a modified web page which not only includes the original web page content, but also includes additional contextual ad information. If the user subsequently clicks on one of the contextual ads, the user's click actions may be logged along with other information relating to the ad (such as, for example, the identity of the sponsoring advertiser, the keywords(s) associated with the ad, the ad type, etc.), and the user may then be redirected to the appropriate landing URL. According to specific embodiments, the logged user behavior information and associated ad information may be subsequently analyzed in order to improve various aspects of the present invention such as, for example, click through rate (CTR) estimations, estimated monetary value (EMV) estimations, etc.

FIG. 2 shows a block diagram of various components and systems of a Kontera Server System 200 which may be used for implementing various aspects of the present invention in accordance with a specific embodiment. At least a portion of the functionalities of various components shown in FIG. 2 are described below. It will be noted, however, other embodiments of the Kontera Server System may include different functionality than that shown and/or described with respect to FIG. 2.

As illustrated in the embodiment of FIG. 2, the Front End component 204 may include, for example, at least one web server, and may be configured or designed to handle requests from one or more client systems (e.g., 202).

The Analysis Engine 206 may be operable to perform real-time analysis of web page content. As illustrated in the example of FIG. 2, the Analysis Engine 206 may include various functionality, including, for example, but not limited to, one or more of the following: functionality for identifying keywords on selected web pages; functionality for combining or linking keywords into groups or concepts; functionality for identifying topics of a web page based on the identified keywords; functionality for identifying aliases for topics associated with selected web pages; functionality for determining various attributes of one or more client systems; functionality for collecting and analyzing user behavior information; functionality for tracking ad impression information; etc.

The Reaction Engine 208 may be operable to utilize information provided by the Analysis Engine 206 to generate real-time web page modification instructions to be implemented by the client system when rendering web page information. According to a specific embodiment, the web page modification instructions may include instructions relating to the insertion of textual markup objects and/or dynamic content for selected web pages being displayed on the client system. As illustrated in the example of FIG. 2, the Reaction Engine 208 may include various functionality, including, for example, but not limited to, one or more of the following: functionality for identifying links between web pages of the same web site and/or between web pages from different web sites; functionality for filtering advertisements based upon predetermined criteria (such as, for example, publisher preferences); functionality for storing information relating to previous analysis of web pages; functionality for selecting or determining recommended web page modification instructions based upon selected user profile information (e.g., user click behavior, Geolocation, etc.); etc.

The Ad Server/Relevancy module 209 may be operable to manage and/or provide access to advertising information and/or related keyword information. For example, In at least one embodiment, Ad providers 220 (e.g., Yahoo, Looksmart, Ask.com, etc.), advertisers, and/or ad campaign providers/managers may provide to the Ad Server/Relevancy module 209 one or more advertisements (ads) relating to one or more different keywords. The Ad Server/Relevancy module 209 may be operable to determine and/or store a respective relevancy score for each ad. Additionally, the Ad Server/Relevancy module 209 may be operable to determine and/or store other ad related information such as, for example: related page topic information, cost-per-click (CPC) information, etc. The Ad Server/Relevancy component 209 may also be operable to be queried by one or more other components/systems such as, for example, Reaction Engine 208. For example, in one embodiment, the Reaction Engine may query the Ad Server/Relevancy module for information relating to a particular ad or keyword, and the Ad Server/Relevancy module may respond by providing relevant information which, for example, may be used by the Reaction Engine to facilitate the selection of one or more keyword/ad candidates.

In at least some embodiments, Ad Server/Relevancy module 209 may be operable provide a variety of other functionalities and/or features, which, for example, may include, but are not limited to, one or more of the following (or combination thereof): functionality for providing identifying and selecting ads that are relevant to the content of the page; functionality for providing analysis operations; functionality for generating ad and page classifier data; functionality for generating ad relevancy scores; etc.

The Redirect & Transformation Engine 225 may be operable to include redirect, translation and/or tracking functionality. For example, in at least one embodiment, the Redirect & Transformation Engine 224 may include various functionality, including, for example, but not limited to, one or more of the following: functionality for redirecting clients to a specified destination; functionality for analyzing and translating data relating to user activity into desired user behavior information; functionality for translating ad related data into displayable format, functionality for tracking and storing information relating to user behaviors, clicks and/or impressions; etc.

Management console 214 may be operable to provide a user interface for creating and viewing reports, setting system configurations and parameters. According to a specific embodiment, the management console 214 may be configured or designed to allow content providers and/or advertisers to access the Kontera Server System in order to, for example: access desired information stored at the Kontera Server System (e.g., keyword taxonomy information, content provider information, advertiser information, etc.); manage and generate desired reports; manage information relating to one or more ad campaigns; etc.

Notification Server 211 operable to manage ad update information and/or related activities or events. In at least one embodiment, the Notification Server 211 may be operable to manage ad update activities, events, and/or related information in real-time.

According to specific embodiments, EMV Engine 233 may be operable provide a variety of functionalities and/or features, which, for example, may include, but are not limited to, one or more of the following (or combination thereof): functionality for providing estimates of the Expected Monitory Value for specified Page, Highlight, ad combinations; functionality for providing analysis and tracking operations; functionality for providing learning users behavior to re-estimate the EMV estimates; functionality for providing back-off estimates; functionality for providing Logistic Regression operations; etc.

According to specific embodiments, Layout Engine 237 may be operable provide a variety of functionalities and/or features, which, for example, may include, but are not limited to, one or more of the following (or combination thereof): functionality for identifying and selecting highlights (e.g., keyword highlights) to be displayed; functionality for generating ad rankings; functionality for providing reaction operations; etc.

According to specific embodiments, Exploration Engine 231 may be operable provide a variety of functionalities and/or features, which, for example, may include, but are not limited to, one or more of the following (or combination thereof): functionality for exploring ads that may yield better value than current ads; functionality for interacting with layout engine, for example, to understand which highlight may be explored; functionality for providing tracking and reaction; etc.

Other components of the Kontera Server System 200 may include, but are not limited to, one or more of the following (or combinations thereof): a chunk parser 212 (such as, for example, a part-of-speech text processor) operable to parse chunks of received web page content and/or to perform analyses of the text syntax; a Middle Tier component 210 configured or designed to include data warehouse and business logic functionality; at least one database 230 for storing information such as, for example, web page analysis information, application data, reports, taxonomy information, ontology information, etc.; a report manager 222 for collecting and storing reports and other information from different components in the Kontera Server System; a Translation Engine 224 for translating or converting communications from one format type to another format type (e.g., from XML to HTML or vice versa); a parsing engine for parsing HTML into readable text; an Ad Center component 213 operable to provide a user interface to one or more advertisers or ad campaign managers (e.g., 215) for performing various operations such as, for example, setting up ad campaigns, managing ad campaigns, generating reports; a Taxonomy component 235 operable to manage, store and/or provide access to taxonomy information (which, for example, may include keyword related information and/or topic related information); etc.

One aspect of at least some embodiments described herein is directed to systems and/or methods for augmenting existing web page content with new hypertext links on selected keywords of the text to thereby provide a contextually relevant link to an advertiser's sites.

Other aspects are directed to one or more techniques for determining and displaying related links based upon keywords of a selected document such as, for example, a web page. For example, one embodiment may be adapted to link keywords from content on a web site (e.g., articles, new feeds, resumes, bulletin boards, etc.) to relevant pages within their site. In embodiments where the selected website includes multiple web pages (which, for example, may include static and/or dynamic web pages), the technique(s) described herein may be adapted to automatically and dynamically determine how to link from specific keywords to the most appropriate and/or relevant and/or desired pages on the website. In at least one embodiment, the most appropriate and/or relevant pages may include those which are determined to be contextually relevant to the specific keywords. For example, using the technique(s) described herein the keyword “DVD player” may be linked to a recently published article reviewing the latest DVD players on the market. In at least one embodiment, it may be preferable to link one or more keywords to pages, articles, URLs or other references which are determined to have the relatively greatest revenue potential as compared to a group of possible candidates which might be appropriate.

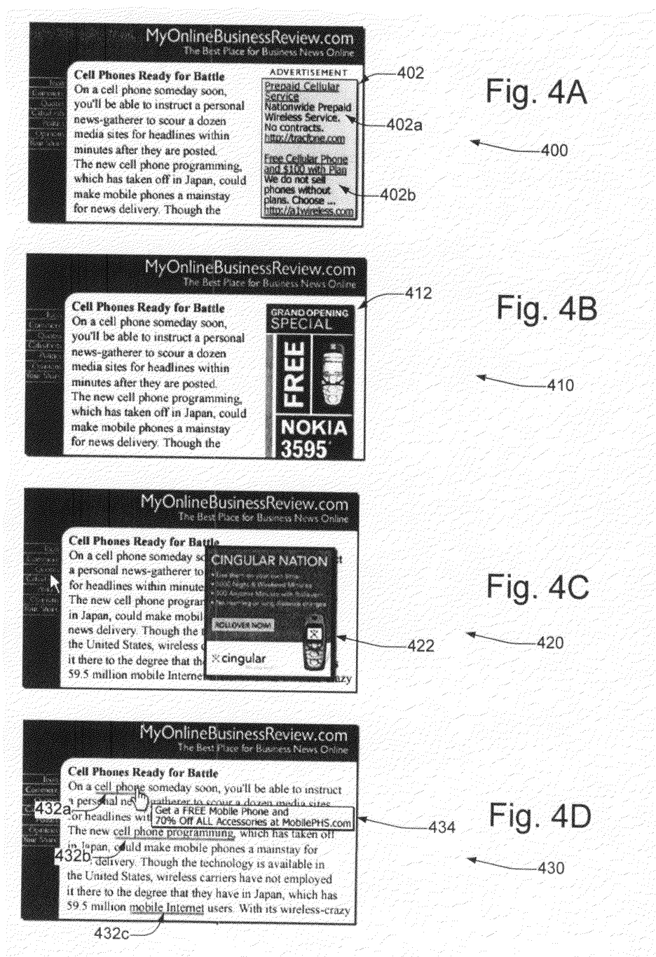

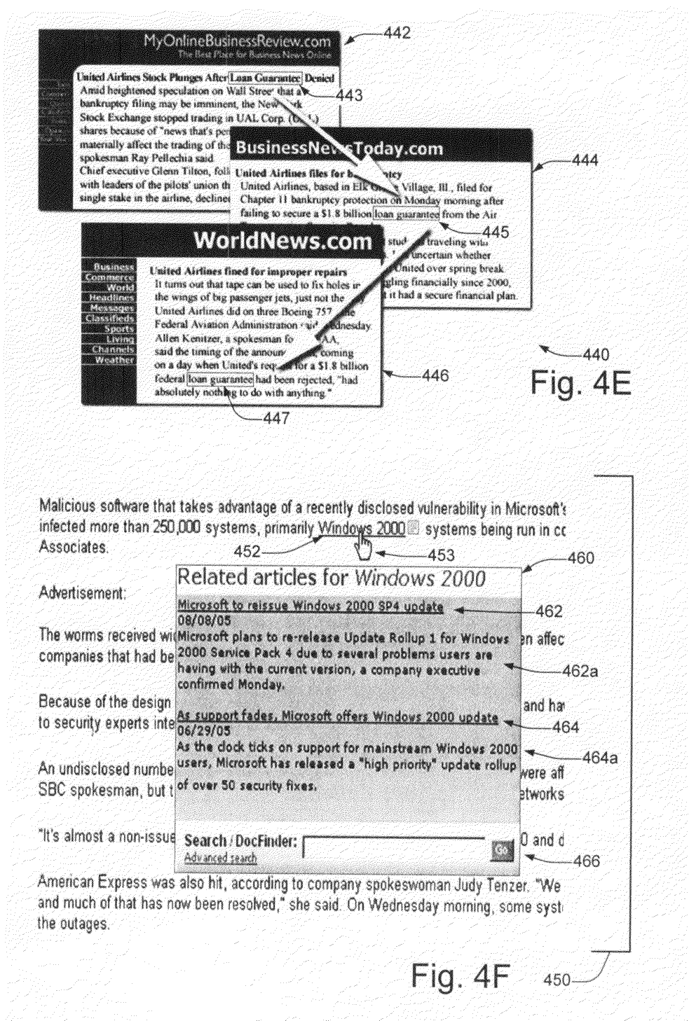

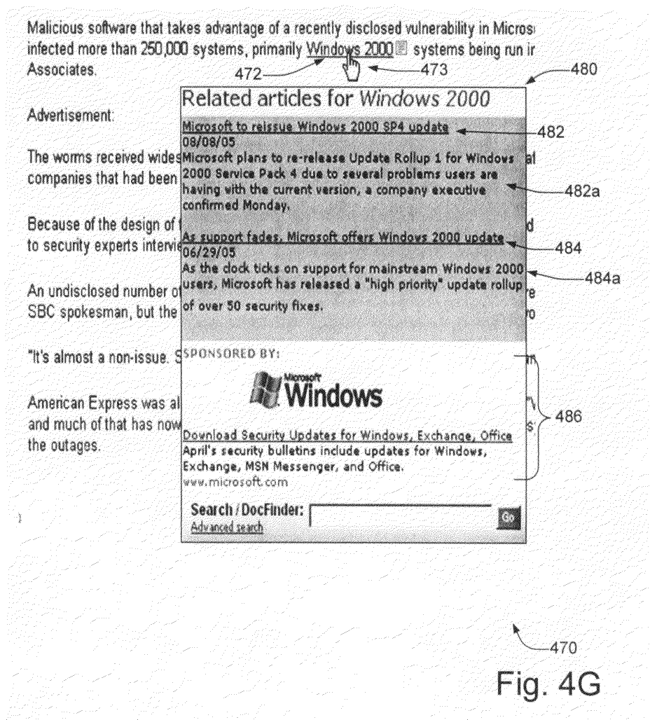

For purposes of illustration, the contextual advertising and markup techniques disclosed herein are described with respect to the use of ContentLinks. However, other embodiments of the present invention may utilize other types of advertising techniques which, for example, may be used for modifying displayed content (and/or for generating modified content) in order to present desired contextual advertising information on a client device display. Examples of at least some advertising techniques which may be utilized in one or more embodiments of the present invention are described, for example, in FIGS. 4A-G of the drawings.

FIGS. 4A-G provide examples of various screen shots which illustrate different techniques which may be used for modifying web page displays in order to present additional contextual advertising information.

FIG. 4A illustrates a technique (herein referred to as “TextMatch”) for placing additional relevant search listings (402a, 402b) or search results next to the relevant web page content. FIG. 4B illustrates a technique (herein referred to as “AdMatch”) for placing relevant marketing opportunities, promotions, graphics, commerce opportunities, ads (412), etc. next to the web page content. FIG. 4C illustrates a technique (herein referred to as “Contextual Pop-ups”) for placing relevant pop-up windows (422) on top or under the current page. The pop-up window(s) may include information relating to content, marketing opportunities, promotions, graphics, commerce opportunities, etc. FIG. 4D illustrates a technique (herein referred to as “ContentLinks”) for placing additional links (432a, 432b) to information (434) (e.g., content, marketing opportunities, promotions, graphics, commerce opportunities, etc.) within the existing text of the web page content by transforming (e.g., marking up) existing text (432a, 432b) into hyperlinks. In one embodiment, the additional information (e.g., 434) may be automatically displayed to the user via a tool-tip layer which may be activated or displayed when the user performs a “mouse over” action on (e.g., hovers the display pointer over) text (e.g., 432a) which has been marked up using one or more of the techniques described herein. In another embodiment, the user may be required to click on the marked up text or hyperlink (e.g., 432a) in order to cause the additional information (e.g., 434) to be displayed. FIG. 4E illustrates a technique (herein referred to as “Related Content Links”) for finding web pages (442, 444, 446) that relate to each other (e.g., by relevant topic or theme), finding relevant keywords (443, 445, 447) on those pages, and then transforming those relevant keywords into hyperlinks that link between the related pages.

FIG. 4F shows an example of a specific embodiment of a graphical user interface (GUI) which may be used for implementing various aspects of the present invention. In the example of FIG. 4F, it is assumed that the content of document 450 has been analyzed in accordance with a contextual analysis technique, and that selected keywords of the document have been identified. It is further assumed that at least a portion of the selected keywords have been linked to other selected resources (e.g., web pages, URLs, articles, etc.) using predetermined selection criteria. Thus, for example, as shown in FIG. 4F, when a user hovers the cursor 453 over the keyword “Windows 2000” (452), a GUI 460 may be displayed to the user, for example, via a pop-up layer (such as, for example, a mouse-over tool tip layer). In the embodiment of FIG. 4F, the GUI 460 includes several links (e.g., 462, 464) to articles relating to the keyword “Windows 2000”. GUI 460 may also include other information such as, for example, images and/or text descriptions (e.g., 462a, 464a) associated with each of the related article links; advertisements; dialog boxes (e.g., search box 466); etc.

FIG. 4G shows an example of an alternate embodiment of a graphical user interface (GUI) which may be used for implementing various aspects of the present invention. In the example of FIG. 4G, it is assumed that the content of document 470 has been analyzed in accordance with a contextual analysis technique, and that selected keywords of the document have been identified. It is further assumed that at least a portion of the selected keywords have been linked to other selected resources (e.g., web pages, URLs, articles, etc.) using predetermined selection criteria. Thus, for example, as shown in FIG. 4G, when a user hovers the cursor 473 over the keyword “Windows 2000” (472), a pop-up window or GUI 480 may be displayed to the user. In the embodiment of FIG. 4G, the GUI 480 includes several links (e.g., 482, 484) to articles relating to the keyword “Windows 2000”. GUI 480 may also include other information such as, for example, images and/or text descriptions (e.g., 482a, 484a) associated with each of the related article links; advertisements (e.g., 486); dialog boxes; etc.

Additionally, in specific embodiments of websites which include dynamically generated web pages with content populated from multiple sources, different mechanisms may be utilized which, for example, are adapted to maintain and/or manage the relationships between set(s) of keywords and dynamically changing list(s) of web pages. Examples of several of such mechanisms are described below.

For example, one or more embodiments may be integrated with the application(s) which a website is using for content management and production. One advantage of such a technique is that it may reduce or eliminate manual work required to be performed, for example, by a site manager. For example, in one embodiment, assuming that the site is using a specific application that manages the content (e.g., categorizes, etc.), it may be preferable to tie into that system in order to learn about the keyword-to-document relationships. Different embodiments may be operable to provide different features/functionalities which, for example, may include, but are not limited to, one or more of the following (or combination thereof): functionality for “reading” a list of documents where each document has an associated category and priority; functionality for connecting a list of keywords to the appropriate documents (based, for example, on a pre-determined relationship between keywords and categories); etc.

Other embodiments may be operable to allow content managers to classify documents into known list of categories. This may allow the site managers to relate specific documents to categories. The different keywords may then be linked to the appropriate documents based on the pre-existing relationship as described above. One advantage of this technique is that it may be implemented without requiring integration into existing applications.

Other embodiments may be operable to use pre-existing Meta information that the site adds to documents, and to categorize the documents based on that Meta info. For example, one embodiment may be adapted to crawl the web pages and/or documents (including, for example, documents which are stored in a database and/or are generated on-the-fly), and to create links from keywords to documents based on given relationships (such as those described herein, for example). In one embodiment, it is assumed that the document includes useful Meta info (e.g., that can be used for one or more purposes as described herein). In some embodiments, the content propagation cycles may be implemented on a period basis, and may be integrated into a crawling schedule.

Other embodiments may be operable to link to documents based on their site-section placement. Thus, for example, in one embodiment, links may be created from keywords of a specific category to the documents in the site's section that matches that category. This takes into consideration that the site's section(s) are somewhat “match able” to the keyword categories.

In at least one embodiment, one or more of the above-described embodiments may be implemented without requiring integration into existing applications.

Other embodiments may be operable to link to documents based on priorities assigned by an operator (such as, for example, a Kontera employee or a CP employee) to specific site sections and/or specific pages. According to a specific embodiment, such priorities may be added to the process that determines which links could be offered for a specific keyword. For example, in at least one embodiment, such priorities may be desirable, for example, in situations where more than one link is relevant (e.g., within a given relevancy spectrum), and it is desired to prioritize the linking of a specific site section or page (e.g., because that section or page may have a higher monetary value associated with it). According to some embodiments, at least some features relating to the real-time contextual advertising techniques described herein may be implemented via the use of dynamic context tags which have been included in selected web pages of an online publisher or content provider. For example, in at least one embodiment, a content provider (such as, for example, on-line publishers or other website operators providing on-line content) may insert one or more dynamic context tags (such as, for example, a Java script tag) into all or selected web pages of a website which, for example, may be hosted by the content provider. In one embodiment, the dynamic context tag information may include a content provider ID which is uniquely associated with that specific content provider. According to a specific embodiment, a dynamic context tag may include various information such as, for example, the content provider ID, information relating to one or more desired ad types (such as, for example, TextMatch, AdMatch, Contextual Pop-ups, ContentLink, Related Content Links, etc.) to be used on the associated web page, script instructions (e.g., JavaScript™ code) to be implemented at the client system; etc. In one embodiment, the dynamic context tag may be physically inserted into each of the selected web pages. Alternatively, the dynamic context tag information may be inserted into the page via a tag that is already all the page such as, for example, and ad server tag or an application server tag. Once present on the page, the dynamic context tag may be served as part of the page that is served from the content provider's web server(s).

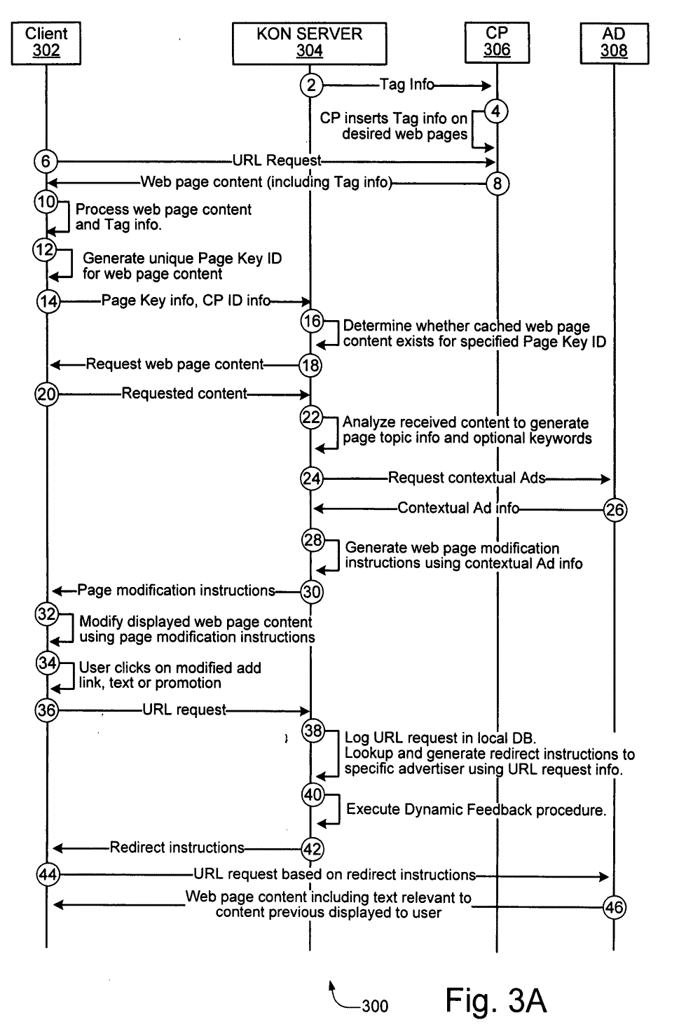

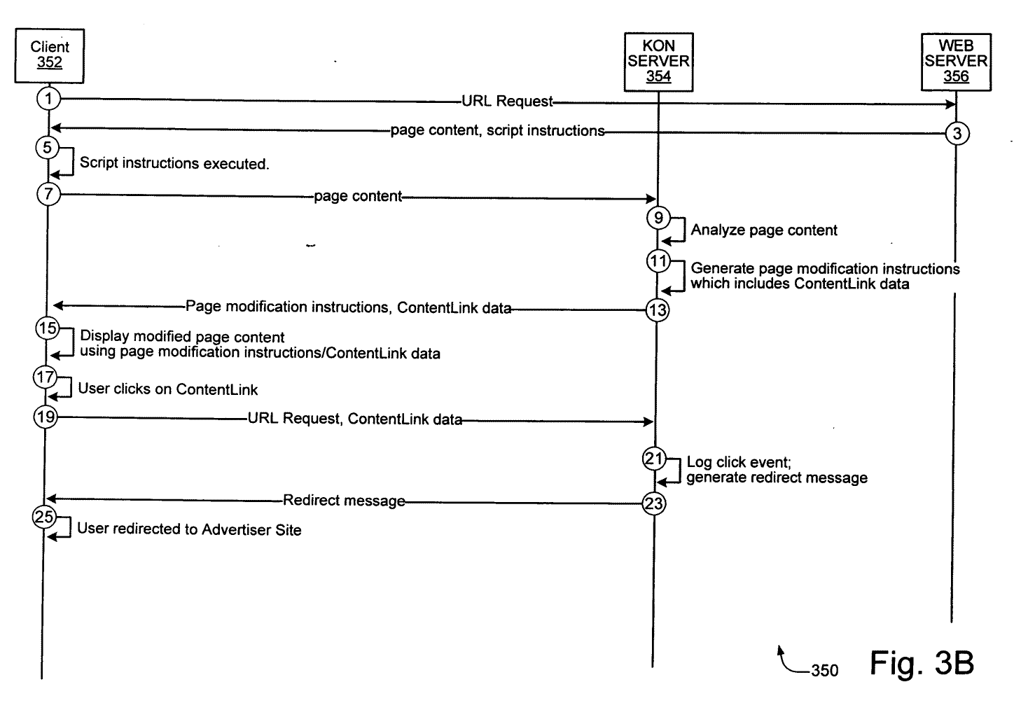

FIG. 3A shows a flow diagram illustrating various information flows and processes of the present invention which may occur at various systems in accordance with a specific embodiment. According to a specific implementation, a content provider (such as, for example, on-line publishers or other website operators providing on-line content) desiring to utilize the real-time contextual advertising features of the present invention may obtain a unique content provider ID. In one implementation, the unique content provider ID may be assigned or provided by the Kontera Server System. In a specific embodiment, the unique content provider ID information may be embedded into a dynamic context tag (such as, for example, a Java script tag) which may then be inserted into the content provider's web pages.

Thus, for example, as illustrated in the example of FIG. 3A, the Kontera Server System (KON) 304 provides (2) dynamic context tag information which includes the unique content provider ID to the content provider server (CP) 306. In at least one implementation, the content provider may utilize the dynamic context tag information to generate one or more dynamic context tags to be inserted (4) on selected web pages which the content provider has identified for utilizing the real-time contextual advertising features of the present invention. According to a specific embodiment, each dynamic context tag may include information relating to the content provider ID, and may also include information relating to one or more desire to add types (e.g., TextMatch, AdMatch, Pop-up, ContentLink, Related Content Links, etc.) for the corresponding web page. In one embodiment, the dynamic context tag may be physically inserted into each of the selected web pages. Alternatively, the dynamic context tag information may be inserted into the page via a tag that is already all the page such as, for example, and ad server tag or an application server tag. Once present on the page, the dynamic context tag will be served as part of the page that is served from the content provider's web server(s).

For example, as shown in FIG. 3A, it is assumed at (6) that a user at the client system 302 has initiated a URL request to view a particular web page such as, for example, www.yahoo.com. Such a request may be initiated, for example, via the Internet using an Internet browser application at the client system. When the URL request is received at the content provider server 306, the server responds by transmitting or serving (8) web page content, including the dynamic context tag, to the client system 302. The client system will then process (10) the received web page content including the dynamic context tag, which includes dynamic context tag information relating to the content provider ID and desired ad types for the retrieved web page. According to a specific embodiment, the processing of the dynamic context tag information will invoke a Java script operation which causes the client system to generate (10) a unique page key ID for the received web page content, and to transmit (12) the page key ID information, desired ad type information, and content provider ID information to the Kontera Server System 304. In at least one embodiment, a page key ID represents a unique identifier for a specific web page, and may be generated based upon text, structure and/or other content of that web page. In a specific implementation, the page key ID is not based upon the identity of the user, client system, or content provider. However, the page key ID may be used to uniquely identify personalized web pages, customized web pages, and dynamically generated web pages.

Upon receiving the page key ID information and content provider ID information, the Kontera Server System uses this information to determine (16) whether a cached version of the web page corresponding to the page key ID already exists within the Kontera Server System cache. According to a specific embodiment, if it is determined that a cached version of the web page exists at the Kontera Server System, then flow may commence starting at operation (24) of FIG. 3A, which is described in greater detail below. However, for purposes of illustration, it is assumed that a cached version of the web page does not exist at the Kontera Server System. Accordingly, the Kontera Server System request (18) the client system to provide at least a portion of the web page content. The client system responds by transmitting (20) the requested web page content to the Kontera Server System. In the specific implementation, the requested content may be transmitted to the Kontera Server System in chunks which may span the one or more sessions.

As the Kontera Server System receives the web page content from the client system, it analyzes (22), in real-time, the received web page content in order to generate page topic information and/or keyword information. According to a specific implementation, the keyword information may include, for example, taxonomy keywords, ontology (or “ContentLink”) keywords, keyword ranking information, primary keyword information, etc. The page topic information may include one or more page topics associated with the web page currently being analyzed. In at least one embodiment, taxonomy keywords may correspond to words or phrases in the web page content which relate to the topic or subject matter of the web page. Ontology or ContentLink keywords may correspond to words or phrases in the web page content which may have advertising value. In some cases, it is possible for a word or phrase to be classified as both a taxonomy keyword and an ContentLink keyword.

In at least one implementation, the Kontera Server System may continue to request and analyze web page content for the specified web page until it has generated a sufficient amount of keyword information (e.g., 5 or more taxonomy keywords and 5 or more ontology keywords), until it has generated a sufficient amount of page topic information, and/or until the entirety of the web page content has been analyzed. Once the Kontera Server System has finished performing its analysis of the web page content, it may then submit a request (24) to one or more advertiser systems 308 for contextual ad information. According to specific embodiments, the ad request(s) may be based on various criteria such as, for example, publisher preferences, page topic information, desired ad data, keyword information, page topic information, etc. Each advertiser system may, in turn, process the ad information request in order to determine if it has relevant advertising information which matches the specified criteria. If so, the advertiser system 308 may transmit (26) contextual ad information to the Kontera Server System. In at least one embodiment, the contextual ad information may include a variety of different information such as, for example, text, images, HTML, scripts, video, audio, proprietary rich media, etc. In addition, the contextual ad information also include URL information and financial information such as, for example, cost per click (CPC) information.

For example, in at least one embodiment, the contextual ad information may include, for example: title information relating to the ad, ad description information, a “click” URL that is to be accessed when the user clicks on the ad, a “landing” URL where the user will eventually be redirected to after the click URL action has been processed, cost-per-click (CPC) information which may include cost-per-click information relating to one or more monetary values which the advertiser will pay for each user click on the ad; and/or some combination thereof.

According to a specific embodiment, it is possible for the Kontera Server System 304 to receive different contextual ad information from a plurality of different advertiser systems. In one implementation, the received ad information may be sorted and/or ranked according to predetermined criteria (such as, for example, CPC criteria, revenue criteria, expected return criteria, type of ad, likelihood of user clicks, statistical historical data, etc.) in order to select the desired ad to be used.

Assuming a desired ad has been selected, the Kontera Server System may then generate (28) web page modification instructions using, for example, the contextual ad information associated with the selected ad, and the desired ad type information specified by the content provider. According to a specific embodiment, the web page modification instructions may include keyword impression information which may be logged at the Kontera Server System database.

Once the web page modification instructions have been generated, they are transmitted (30) to the client system. In a specific embodiment, the web page modification instructions may be implemented using a scripting language such as, for example, Java script. When the web page modification instructions are received at the client system, the client system processes the instructions, and in response, modifies (32) the display of the web page content in accordance with the page modification instructions.

According to at least one embodiment, the web page modification instructions may include instructions for modifying, in real-time, the display of web page content on the client system by inserting and/or modifying textual markup information and/or dynamic content information. Because the web page modification operations are implemented automatically, in real-time, and without significant delay, such modifications may be performed transparently to the user. Thus, for example, using the technique(s) described herein, when the user submits a URL request at the client system to view a web page (such www.yahoo.com, for example), the client system will receive web page content from www.yahoo.com, and will also receive web page modification instructions from the Kontera Server System. The client system will then render the web page content to be displayed in accordance with the received web page modification instructions. Examples of various screen shots which illustrate different techniques which may be used for modifying web page displays in order to present additional contextual advertising information are illustrated, for example, in FIGS. 4A-4G of the drawings.

At (34) it is assumed that the user has clicked on one of the contextual ads which was dynamically inserted into the web page content using the above-described technique. According to at least one embodiment, the action of the user clicking on one of the contextual ads causes the client system to transmit (36) a URL request to the Kontera Server System. The URL request may be logged (38) in a local database at the Kontera Server System when received. The URL may include embedded information allowing the Kontera Server System to identify various information about the selected ad, including, for example, the identity of the sponsoring advertiser, the keywords(s) associated with the ad, the ad type, etc. The Kontera Server System 304 may use at least a portion of this information to generate (38) redirected instructions for redirecting the client system to the identified advertiser. Additionally, the Kontera Server System may also use at least a portion of the URL information during execution (40) of a dynamic feedback procedure. In at least one embodiment, the dynamic feedback procedure may be implemented to record user click information and impression information associated with various keywords.

As shown at (42), the Kontera Server System transmits the redirected instructions to the client system 302. In response, the client system is redirected to transmit (44) a new URL request to Ad Server 308. The Ad Server may then respond by serving (46) web page content corresponding to the URL request to the client system 302. In at least one embodiment, the web page content sent from the ad Server 308 may include text or other information relevant to content of the web page previously displayed to the user.

FIG. 3B shows an alternate embodiment of flow diagram illustrating various information flows and processes which may occur at various systems in accordance with a specific embodiment.

In the example of FIG. 3B, it is assumed at (1) that a user at the client system 352 has initiated a URL request to view a particular web page (such as, for example, www.yahoo.com), which, for example, is being hosted at web server system 356. Such a request may be initiated, for example, via the Internet using an Internet browser application running at the client system 352.

When the URL request is received at the web server system 356, the web server system may respond by transmitting or serving (3) to the client system the requested page content, which, for example, may include a dynamic context tag containing script instructions (and/or other executable code).

As shown at (5) it is assumed that the page content and dynamic context tag information are received at the client system. In at least one embodiment, the script instructions may include instructions or code intended for execution at the client system which, for example, may cause the client system to initiate communication with a remote system such as, for example, the Kontera Server System 354. More specifically, in the example of FIG. 3B, it is assumed that the client system has initiated processing of the dynamic context tag information which invokes execution (6) of the script instructions which, in turn, causes the client system to transmit (7) all or selected portions of the page content (and/or other information such as, for example, the content provider ID, desired ad type information, etc.) to the Kontera Server System for contextual advertising analysis.

In at least one embodiment, as the Kontera Server System 354 receives the page content, it analyzes (9) (e.g., in real-time) the received page content, and generates (11) page modification instructions which includes ContentLink data relating to one or more ContentLink(s) to be displayed on the client system display.

It is noted that, for purposes of illustration, the contextual advertising and markup techniques disclosed herein are described with respect to the use of ContentLinks. However, other embodiments of the present invention may utilize other types of advertising techniques which, for example, may be used for modifying displayed content (and/or for generating modified content) in order to present desired contextual advertising information on a client device display. Examples of at least some advertising techniques which may be utilized in one or more embodiments of the present invention are described, for example, with respect to FIGS. 4A-G of the drawings.

According to specific embodiments, at least a portion of the page modification instructions and/or ContentLink data may be generated using a variety of conventional on-line contextual advertising techniques such as, for example, those described in: U.S. patent application Ser. No. 10/977,352 (U.S. Publication No. US20050149395A1), and/or U.S. patent application Ser. No. 10/645,313 (U.S. Publication No. US20050004909A1), each of which is incorporated herein by reference in its entirety for all purposes.

In at least one implementation, the Kontera Server System may continue to process the page content until it has generated a sufficient amount of page modification instructions, ContentLink data, and/or until the entirety of the page content has been analyzed.

In at least one embodiment, the page modification instructions and/or ContentLink data may include various information such as, for example: information which describes how specific text and/or other content (e.g., of the page content) is to appear when displayed; information relating to one or more hyperlinks (e.g., ContentLinks) to be included in the display of the page content; information relating to specific advertisements which are associated with one or more ContentLinks such as, for example: title information relating to a selected ad, content relating to the ad, a “click” URL that is to be accessed when the user clicks on the ad, a “landing” URL where the user will eventually be redirected to after the click URL action has been processed, etc.

As shown at (13), the Kontera Server System 354 may send the page modification instructions and/or ContentLink data to the client system 352.

As shown at (15) the client system may use the page modification instructions and/or ContentLink data to display modified page content which includes at least one ContentLink (as shown, for example, in FIG. 4D of the drawings). According to one embodiment, a browser application running at the client system may be operable to modify the page content using the page modification instructions and/or ContentLink data to thereby render modified page content for display on the client system display. In some embodiments, the client system may be operable to processes the page modification instructions to thereby display modified page content formatted in accordance with the web page modification instructions. In other embodiments, the Kontera Server System may perform the task of modifying the original page content to thereby generate the modified page content, which may then be transmitted to the client system for display.

Because the web page modification operations are implemented automatically, in real-time, and without significant delay, such modifications may be performed transparently to the user. Thus, for example, from the user's perspective, when the user requests a particular web page to be retrieved and displayed on the client system, the client system will respond by displaying modified page content which not only includes the original page content, but also includes additional contextual ad information.

In the embodiment of FIG. 3B, it is assumed (for illustrative purposes) that the displayed modified page content includes at least one ContentLink as shown, for example, in FIG. 4D of the drawings. For purposes of illustration, the flow diagram of FIG. 3B, will continue to be described by way of example with reference to FIG. 4D of the drawings.

As illustrated in the embodiment of FIG. 4D, modified page content portion 430 includes a first ContentLink 432a. According to one embodiment, the process of generating ContentLink 432a may include a number of different operations such as, for example: identifying and selecting a portion of text (e.g., “cell phone”) included in the original page content, identifying a first ad or advertisement to be associated with the selected portion of text, converting the selected portion of text (e.g., “cell phone”) into a hyperlink, and/or associating the hyperlink with one or more characteristics relating to the first ad such as, for example: content relating to the ad, a “click” URL that is to be accessed when the user clicks on the ad, a “landing” URL where the user will eventually be redirected to after the click URL action has been processed, etc. In at least one embodiment, the selected portion of text (e.g., “cell phone”) may correspond to a keyword which has been identified by an advertiser and/or ad campaign provider as being related to one or more types of advertising categories and/or topics. As illustrated in the example of FIG. 4D, when the user hovers the mouse pointer over ContentLink 432a, additional information 434 may automatically be displayed to the user, for example, via a mouse-over tool tip layer. In at least one embodiment, the additional information 434 may include ad-related information which is contextually related to ContentLink 432a and/or to other identified keywords and/or topics associated with page content.

It is assumed at (17) (FIG. 3B) that the user of the client system selects (e.g., click on) one of the displayed ContentLinks (e.g., user selects of clicks on ContentLink 432a, FIG. 4D).

In at least one embodiment, the action of the user selecting or clicking on a specific ContentLink (e.g., ContentLink 432a) causes the client system to transmit (19) a URL request and/or other information relating to the selected ContentLink to the Kontera Server System. In one embodiment, ContentLink information sent from the client system to the Kontera Server System may include information allowing the Kontera Server System to identify various information about the selected ad, such as, for example: the identity of the sponsoring advertiser, the keywords(s) associated with the ad, the ad type, landing URL, etc. In one embodiment, information relating to the URL request and/or other information relating to the user's actions may be logged by the Kontera Server System for subsequent analysis.

As shown at (21) the Kontera Server System may log click event information, and may generate a redirect message to be transmitted (e.g., 23) to the client system for redirecting (e.g., 25) the client system to an appropriate landing URL (e.g., the advertiser's site www.orange.co.uk, or to another site selected by the advertiser). In other embodiments, a redirect server (not shown) may be used to redirect the client system to an appropriate landing URL.

Another aspect of the present invention relates to a keyword taxonomy technique (herein referred to as “DynamiContext (DC) taxonomy”) for facilitating contextual analysis of document content.

Specific embodiments of the DynamiContext (DC) taxonomy have been developed to specifically serve a real time contextual analysis system. Specific embodiments of the taxonomy techniques described herein may encompass a hierarchical classification of keywords and topics while maintaining the principles underlying the relationship and context behind these entities.

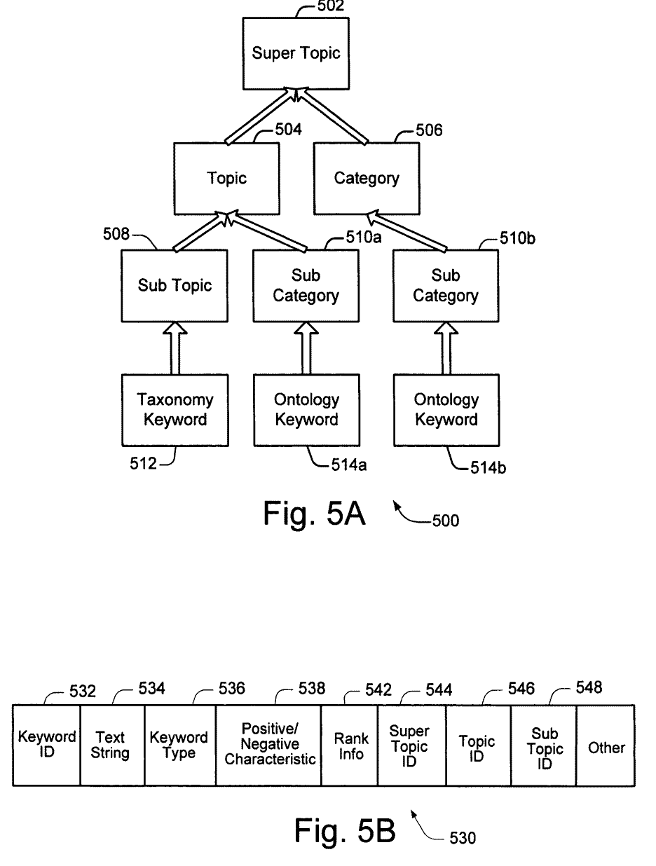

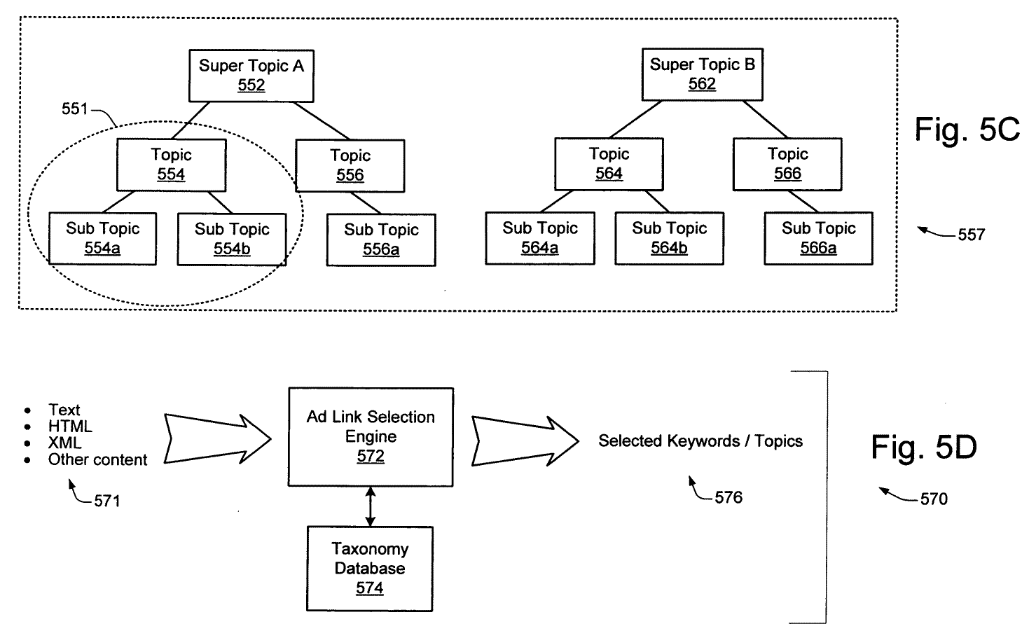

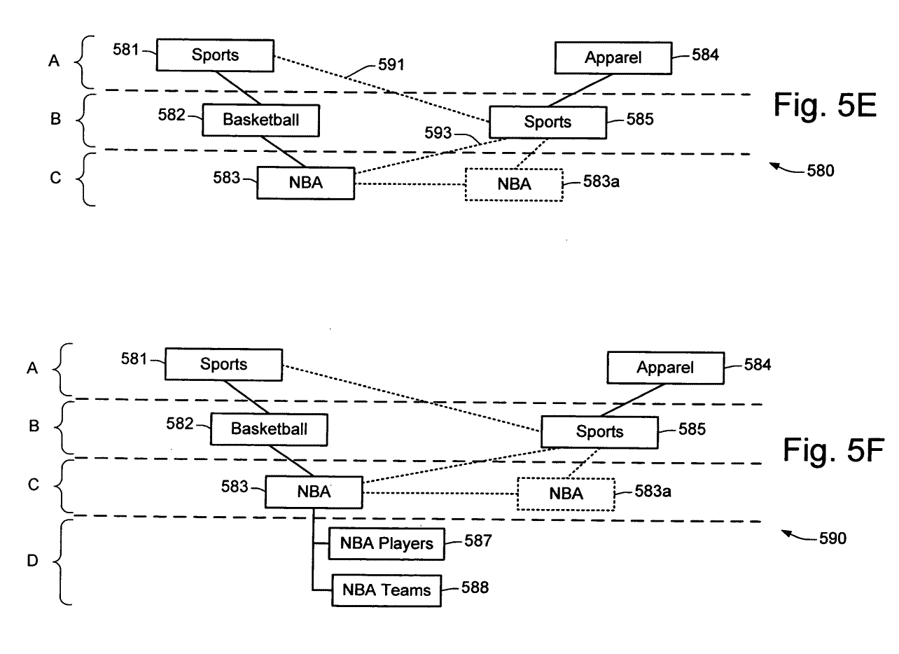

According to specific embodiments, the DC taxonomy may be organized as a tree structure that represents the hierarchical structure and relationship of content. An example of this is shown in FIG. 5A.

FIG. 5A shows an example of a taxonomy structure 500 in accordance with a specific embodiment.

Referring to the example DC taxonomy structure of FIG. 5A, the taxonomy's root node is called Super Topic. Under the root node, there is another node that is called Topic, and under Topic, there are nodes called Sub Topic. The Keywords may be classified in the taxonomy per level. For example, in one implementation, general keywords may be classified under SuperTopic, more specific keywords may be classified under Topic, and even more specific keywords may be classified under SubTopic.

According to a specific embodiment, each keyword may have several properties, such as, for example, location based properties, keyword specific properties, etc. For example, in one implementation, a keyword may include one or more of the following properties:

Negative/Positive keyword filtering

Keyword weight

Keyword type

Keyword attribute

Other properties

Such properties enable one to fine-tune contextual relevancy and analysis usage with respect to analyzed content.

As illustrated in the example of FIG. 5A, the keyword/topic classification scheme may include a plurality of hierarchical classifications (e.g., keywords, subtopics, subcategories, topics, categories, super topics, etc.). The highest level of the hierarchy corresponds to super topic information 502. In one implementation, the super topic may correspond to a general topic or subject matter such as, for example, “sports”. The next level in the hierarchy includes topic information 504 and category information 506. In one implementation, topic information may correspond to subsets of the super topic which may be appropriate for contextual content analysis. For example, “basketball” is an example of a topic of the super topic “sports”. Category information, on the other hand, may correspond to subsets of the super topic which may be appropriate for advertising purposes, but which may not be appropriate for contextual content analysis. For example, “sports equipment” is an example of a category of the super topic “sports”.

The next level in the hierarchy includes sub-topic information 508 and sub-category information 510a, 510b. In one implementation, sub-topic information may correspond to subsets of topics which may be appropriate for contextual content analysis. For example, “NBA” is an example of a sub-topic associated with the topic “basketball”. Sub-category information may correspond to subsets of topics and/or categories which may be appropriate for advertising purposes, but which may not be appropriate for contextual content analysis. For example, “NBA merchandise” is an example of a sub-category of topic “basketball”, and “foosball” is an example of a sub-category associated with the category “sports equipment”. The lowest level of the hierarchy corresponds to keyword information, which may include taxonomy keywords 512, ontology keywords 514a, 514b, and/or keywords which may be classified as both taxonomy and ontology. In at least one embodiment, taxonomy keywords may correspond to words or phrases in the web page content which relate to the topic or subject matter of a web page. Ontology (or “ContentLink”) keywords may correspond to words or phrases in the web page content which are not to be included in the contextual content analysis but which may have advertising value. For example, “LA Lakers” is an example of a taxonomy keyword of sub-topic “NBA”, “Air Jordan” is an example of an ontology keyword associated with the sub-category “NBA merchandise”, and “foosball table” is an example of an ontology keyword associated with the sub-category “foosball”.

FIG. 5B shows an example of a keyword taxonomy database record 530 in accordance with a specific embodiment. According to at least one embodiment, the keyword taxonomy database record may include a plurality of different fields (532-548) for recording various information about a selected keyword. For example, the keyword taxonomy database record may include: a keyword ID field 532 which includes keyword ID information relating to a selected keyword; a text string field 534 which includes information relating to the keyword text string; a keyword type field 536 which includes information relating to the keyword type (e.g., taxonomy, ontology, or both); a rank information field 542 which includes information relating to relative ranking of that keyword within the keyword taxonomy database; a super topic ID field 544 which includes information relating to at least one super topic associated with that particular keyword; a topic ID field 546 which includes information relating to at least one topic (if any) associated with that particular keyword; and a topic ID field 548 which includes information relating to at least one sub-topic (if any) associated with that particular keyword. The keyword taxonomy database record may also include other fields 548 which may include other information such as, for example, category information (if any), subcategory information (if any), pricing information (e.g., average CPC price for keyword and/or topic), etc.

According to one embodiment, one aspect of at least some of the various technique(s) described herein provides content providers with an efficient and unique technique of presenting desired information to end users while those users are browsing the content providers' web pages. Moreover, at least some of the various technique(s) described herein enable content providers to proactively respond to the contextual content on any given page that their customers/users are currently viewing. According to at least one implementation, at least some of the various technique(s) described herein allow a content provider to present links, advertising information, and/or other special offers or promotions which that are highly relevant to the user at that point in time, based on the context of the web page the user is currently viewing, and without the need for the user to perform any active action. As described previously, the additional information to be displayed to the user may be delivered using a variety of techniques such as, for example, providing direct links to other pages with relevant information; providing links that open layers with link(s) to relevant information on the page that the user is on; providing links that open layers with link(s) to relevant information on the page that the user is on; providing layers that open automatically once the user reaches a given page, and presenting information that is relevant to the context of the page; providing graphic and/or text promotional offers, etc.; providing links that open layers with content that is served from an external (third party content server) location, etc.

Moreover, it will be appreciated that at least some of the various technique(s) described herein provide a contextual-based platform for delivering to an end user in real-time proactive, personalized, contextual information relating to web page content currently being displayed to the user. In addition, the contextual information delivery technique(s) described herein may be implemented using a remote server operation without any need to modify content provider server configurations, and without the need for any conducting any crawling, indexing, and/or searching operations prior to the web page being accessed by the user. Furthermore, because at least some of the various technique(s) described herein are able to deliver additional contextual information to the user based upon real-time analysis of web page content currently being viewed by the user, the contextual information delivery technique(s) described herein may be compatible for use with static web pages, customized web pages, personalized web pages, dynamically generated web pages, and even with web pages where the web page content is continuously changing over time (such as, for example, news site web pages).

One advantage of using the taxonomy technique(s) described herein for the purpose of contextual advertising is the ability to classify content based on the taxonomy structure. This property provides a mechanism for matching related terms and advertisements from related taxonomy nodes. Thus, for example, using a keyword taxonomy expansion mechanism of the present invention, at least some of the various technique(s) described herein may be adapted to automatically and/or dynamically we bring related advertising from sibling taxonomy nodes, and then use self learning automated optimization algorithms to automatically assign more impressions to the terms that may be identified as being relatively better performers.

In one implementation, the DC taxonomy may be adapted to be generically adaptable so that it can handle dynamic content from different content categories without special setup or training sets. For example, using at least some of the various technique(s) described herein, new terms that are discovered on the page (e.g., new products, movie titles, personalities, etc.) may be matched to base topics that include similar terms (e.g., using a “fuzzy match” algorithm), thereby resulting in a virtual expansion of the DC taxonomy in order to successfully handle and process the new content. Utilizing such virtual expansion capability allows the DC taxonomy to remain relatively compact, without compromising classification quality, thereby allowing one to maintain optimal performance which, for example, may be considered to be an important factor when implementing such techniques in a real time system.

It will be appreciated that different embodiments of taxonomy data structures may differ from the data structures illustrated, for example, in FIGS. 5A, 5B and 5C of the drawings. For example, in at least one embodiment, a “dynamic node taxonomy” data structure may be utilized in which there is no restriction on the number of hierarchical levels and/or nodes which may be utilized, for example, to capture the contextual essence of a specific topic, keyword and/or category and its relation to other topics, keywords, and/or categories. For example, in one embodiment, it would be possible to add as many nodes and/or sub-nodes as desired in order to capture the contextual essence of a topic and its relation to other topics. Additionally, in at least one embodiment, the dynamic node taxonomy data structure may provide the ability to cross reference specific nodes and/or sub-nodes in order, for example, to enable a specific node or sub-node to be linked to (or referenced by) more than one other node and/or sub-node.

FIGS. 5E and 5F illustrate examples of portions of dynamic node taxonomy data structure in accordance with a specific embodiment. In the example of FIG. 5E, a portion 580 of a dynamic node taxonomy data structure is illustrated as including a plurality of nodes (e.g., 581-585), wherein each node is associated with at least one hierarchical level (e.g., A, B, C). In the example of FIG. 5E, node 581 (“Sports”) and node 584 (“Apparel”) are associated with a relatively highest level (e.g., Level “A”) of taxonomy portion 580. Node 582 (“Basketball”) and node 585 (“Sports”) are associated with Level “B”, which is subordinate to Level A. Accordingly in one embodiment, node 582 (“Basketball”) may be considered a sub-node of node 581 (“Sports”), and node 585 (“Sports”) may be considered a sub-node of node 584 (“Apparel”). Node 583 (“NBA”) is associated with Level “C”, which is subordinate to Level B. Accordingly in one embodiment, node 583 (“NBA”) may be considered a sub-node of node 582 (“NBA”).

As illustrated in the example of FIG. 5E, the dynamic node taxonomy data structure provides the ability to cross reference specific nodes and/or sub-nodes in order, for example, to enable a specific node or sub-node to be linked to or referenced by more than one other node and/or sub-node. For example, as illustrated in the example of FIG. 5E, node 583 (“NBA”) may be linked to (or otherwise associated with) both node 582 (“Basketball”) and node 585 (“Sports). In one embodiment, node 583 (“NBA”) may be directly linked to node 585 (“Sports) via a pointer or link (e.g., 593). In other embodiments, node 583 (“NBA”) may be linked to node 585 (“Sports) via a mirror node 583a which, for example, may be specifically configured or designed to represent crossed referenced associations.

Additionally, as shown in the example of FIG. 5E, linked relationships may be established between specific nodes and/or sub-nodes which are members of different levels of the taxonomy hierarchy. For example, as shown in the example of FIG. 5E, node 581 (“Sports”) may be linked to (or associated with, e.g., via link 591) node 585 (“Sports”). In at least one embodiment, node 581 (“Sports”) may be interpreted as relating generally to any type of sports-related topics or subtopics, whereas node 585 (“Sports”) may be interpreted as relating more specifically to sport apparel.

As mentioned previously, in at least some one embodiments, it may also be possible to add as many nodes and/or sub-nodes as desired in order to capture the contextual essence of a specific topic, keyword and/or category and its relation to other topics, keywords, and/or categories. For example, referring to the example of FIG. 5E, it would be possible, if desired, to add additional nodes representing “NBA Players” and “NBA Teams” as sub-nodes of node 583 (“NBA”). An example of this is illustrated and FIG. 5F.

As shown in the example of FIG. 5F, node 587 (“NBA Players”) and node 588 (“NBA Teams”) have been added to the dynamic node taxonomy data structure (e.g., of FIG. 5E) as sub-nodes of node 583 (“NBA”). The addition of nodes 587 and 588 includes the creation of a new hierarchical level (e.g., Level “D”), which is subordinate to Level C. If desired, additional nodes and/or levels may also be added to the data structure in order to capture the contextual essence of a specific topic, keyword and/or category and its relation to other nodes in the data structure (which, for example, may represent different topics, keywords, and/or categories). In at least one embodiment additional links (and/or other related-node linking mechanisms such as, for example, mirror nodes, pointers, etc.) may also be created, for example, in order to associate or link node 587 (“NBA Players”), node 588 (“NBA Teams”) and/or node 583 (“NBA”) with node 585 (“Sports”).

Another aspect of at least some of the various technique(s) described herein relates to an improved advertisement selection technique based on contextual analysis of document content.

FIG. 5D shows a block diagram of a specific embodiment graphically illustrating various data flows which may occur during selection of one or more keywords and/or topics. As shown in the example of FIG. 5D, document content 571 (e.g., text, HTML, XML, and/or other content) may be provided to ContentLink Selection Engine 572. In one embodiment, the ContentLink Selection Engine may perform a contextual analysis of the input content 571 using information from Taxonomy Database 574, which, for example, may result in the identification and/or selection of one or more keywords and/or topics 576. In one embodiment, the identified keywords/topics may be used to select one or more ads to be displayed to the user, for example, via one or more ContentLinks.

In at least one embodiment, it may be desirable to select, in real-time, the most desirable and/or appropriate ContentLinks for a given web page. In one embodiment, the most desirable/appropriate ContentLinks may be at least partially determined based upon Keyword Quality Index values for identified keywords on a given web page.

In one embodiment, the Keyword Quality Index value may be expressed as:

Keyword Quality Index=ƒ(CTR, CPC, Relevancy, Conversion),

where:
CTR=Click through rate;
CPC=Cost per click;
Relevancy=Relevancy between keyword and page topic;
Conversion=Likelihood that user will perform desired action(s) at advertiser's site.

In one embodiment, it may be desirable to increase effective CPM (revenue/cost per 1,000 impressions) for a given page (e.g., web page) by maximizing the following scoring function:

Score (words, page)=_{arg max}Σ P_{click}(wᵢ|page)*CPC(wᵢ),

where:
P_{click} (wᵢ |page) represents the probability of a user click on a specific word given the page information (topics, word score, word position, etc);
CPC(wᵢ) represents cost per click.

In one embodiment, the click-through rate (CTR) data may be computed using one or more of the following parameters:
P_{click} (Wᵢ|page)=the probability of a user click on a specific word given the page information (topics, word score, word position, etc). In one embodiment, the specific page properties may be combined with the click history. In one embodiment, the CTR of a given word (e.g., identified keyword) may depend on its history. Other parameters may be used as weighted values that take into account other parameters such as, for example, the relative strength of the word on a specific page, its location, other links, etc.;
CTR(wᵢ, context)=CTR of a selected word in and/or out of context (e.g., CTR of the keyword phrase “Credit Card” as applied to finance related pages, and as applied to non-finance related pages). According to one embodiment, a first CTR value (or first set of CTR values) may be used for “in context” applications, and a second CTR value (or second set of CTR values) may be used for “out of context” applications.

At least some embodiments may be adapted to estimate the CTR of words that do not have sufficient data accumulated (e.g., impressions, using topic data, context data, word properties, etc.) for calculation of a CTR value based on such data.

For example, in one embodiment, the CTR may be estimated for a given word according to:

CTR_{unknown}(wᵢ, context)=α₁CTR_{click}(topic)+CTR_{click}(context)+αCTR_{click}(length)

where:
CTR_{click}(topic)=the CTR for a specific topic (e.g., total topic clicks/total topic impressions);
CTR_{click}(context)=the CTR for words in/out of context (e.g., total clicks in context/total impressions in context);
CTR_{click}(length)=the probability of click on word of different length (e.g., 1,2,3 etc.);
α₁, α₂, α₃ represent weighted parameters which may be dynamically or statically configured.

According to a specific embodiment, the Score parameter for a given word may be computed as follows:

Score (words,page)=Σ P_{click}(wᵢ|page)*CPC(wᵢ).

where:
P_{click} (wᵢ|page)=F_{click} (wᵢ, context, W_{score}, Wₚₒₛᵢₜᵢₒₙ, Wᵣₑₚₑₜᵢₜᵢₒₙ);
F_{click} (wᵢ, context,W_{score},Wₚₒₛᵢₜᵢₒₙ)=CTR(wᵢ, context)*W_{score}*Wₚₒₛᵢₜᵢₒₙ*Wᵣₑₚₑₜᵢₜᵢₒₙ*W_{context};
Wₚₒₛᵢₜᵢₒₙ(wᵢ=γ^{paragraph #} (½<γ<1) (e.g., decline in click likelihood every time we move to a lower paragraph);
W_{score}(wᵢ)=γ^{score} (1<γ<1.5);
Wᵣₑₚₑₜᵢₜᵢₒₙ=γ^{repetion#} (0<γ<1); for example, if word appears once Wᵣₑₚₑₜᵢₜᵢₒₙ value may be equal to 1. A penalty may be imposed for each additional occurrence of the word such as, for example, by reducing the Wᵣₑₚₑₜᵢₜᵢₒₙ value. In one embodiment, this parameter may be used during the final selection of the ContentLink words, since, for example, until the Wᵣₑₚₑₜᵢₜᵢₒₙ values may not be known until the final keyword candidates have been selected.
W_{context}=punish words that are out of context, for example, by creating a bias toward contextual selection (e.g., W_{context}<1 for non-contextual words);
CTR(wᵢ, context)=value may depend on the relationship between Impression (wᵢ) and K, where K represents a minimum number of impressions such as, for example:
   (i) Impression (wᵢ)>K:

CTR(wᵢ, context)=clicks(wᵢ,context)/impressions(wᵢ,context) (e.g., from the history compute the CTR for the word in context or out of context);
(ii) Impression (wᵢ)<K:

CTR(wᵢ,context)=α₁P_{click}(category)+α₂P_{click}(context)+α₃P_{click}(length).

According to a specific embodiment, after scoring all desired ContentLink candidates on a given page, one objective is to select the appropriate ContentLinks which will maximize the Score parameter. However, in at least one embodiment, it may be preferable to select the final ContentLinks based on one or more predefined constrains. Such constrains may include, but are not limited to, one or more of the following (or combination thereof):
keywords restrictions;
sensitivity restrictions; (e.g., words not suitable for children);
ContentLink limit per page and paragraph;
minimum distance between ContentLinks;
do not highlight ContentLinks below a certain threshold to avoid cannibalization;
some publishers only allow contextual ContentLinks;
some publishers may only get direct ContentLinks (approval type);
minimum CPC restrictions;
etc.

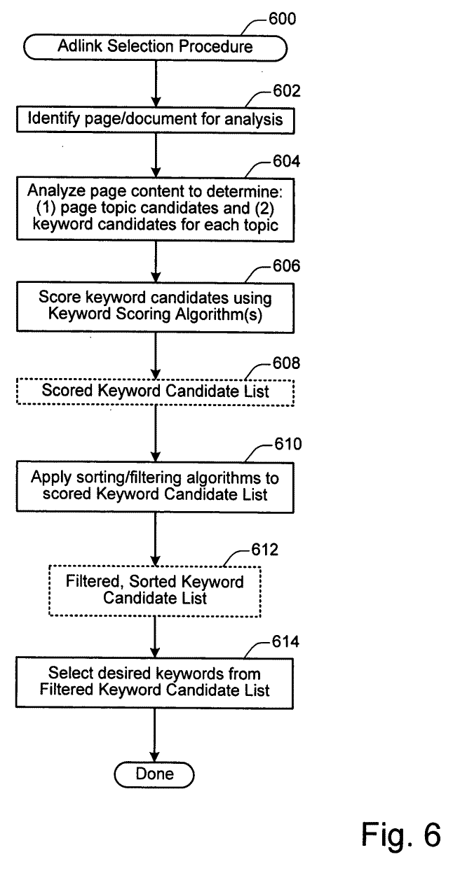

FIG. 6 shows a flow diagram of an ContentLink Selection Procedure 600 in accordance with a specific embodiment. In at least one embodiment, the least a portion of the ContentLink Selection Procedure of FIG. 6 may be implemented at the Kontera Server System. At 602 a document or page (e.g., web page) is identified for analysis.

At 604 the page content is analyzed to determine, for example, (1) page topic candidates and (2) keyword candidates for each topic. In at least one embodiment, it is possible for the same keyword to be associated with different topics (e.g., the keyword “car” may be associated with the topic “auto” and the topic “sound system”). In this example it is assumed that the identified page includes about 60 keyword candidates from which 6 final keywords (or key phrases) will be selected to be converted to ContentLinks.

At 606 the identified keyword candidates are scored using one or more keyword scoring algorithms such as those described previously.

At 608 it is assumed that a scored keyword candidate list is generated which includes keyword candidates and associated keyword scores. In one embodiment, the scored keyword candidate list may include keyword candidates and associated keyword scores

At 610 one or more sorting/filtering algorithms may be applied to the scored Keyword Candidate List using various constraints (such as those described previously, for example). Keyword candidates not satisfying these constraints may be eliminated from the list.

At 612 it is assumed that a filtered, sorted Keyword Candidate List is generated. In at least one embodiment, the top N keywords in the list (e.g., top 6 keywords) may be selected for ContentLink embodiment.

In alternate embodiments one or more keywords of a selected page (and/or other content selected for analysis) may be identified and/or selected without the use of a taxonomy database. For example, in one embodiment, one or more keywords may be automatically and dynamically identified and/or selected based on predetermined selection criteria and/or based one or more algorithms utilizing predefined rules. For example, according to different embodiments, keyword identification and/or selection may be dynamically performed based one or more of the following (or combinations thereof): natural language processing rules; heuristic interpretation of selected text or other portions of content; statistical presence of identified text in similar content; word extensions based on existing keywords in the taxonomy (e.g., where the taxonomy includes the keyword “Lexus”, and additional keywords “New Lexus” and “Lexus 530i” are dynamically identified in the text of the analyzed content); overlaps of two or more existing keywords in the taxonomy (e.g., where the taxonomy includes “server”, “computer”, and “open source” as separate keywords, and a new keyword “open source computer server” is dynamically identified in the text of the analyzed content); etc.

Feedback

According to specific embodiments, a feedback technique may be used to update the scores of topics and keywords. The topics and/or keywords may then be sorted based on the adjusted scores.

According to a specific embodiment, the modified topic/keyword scores may be calculated according to the following formula:

Score=orginialScore*feedbackWeight* bidK,

where:
bidk=the bonus given when we use bid CTR vs. action CTR;
feedbackWeight=(entity CTR)/(avg CTR)=(entityClicks/entity Imps)/(globalClicks/global Imps)

According to one embodiment, EntityClicks and globalClicks may be based on one or more of the following:
bided or for action clicks (e.g., if there are enough bid clicks then use bid clicks, else use action clicks);
specific URL(s) or for specific publisher(s) (e.g., if page had more the minimum impressions per URL, per publisher, etc.);
topic;
keyword;
etc.

According to one embodiment, Entity Impressions (“Imps”) and globalImps may be based on one or more of the following:
URL or for specific publisher(s);
Topic;
Keyword;
etc.

Another aspect is directed to various techniques for facilitating topic expansion and automated learning/optimization of topic selection in advertising environments such as those employing contextual in-text keyword advertising techniques for displaying advertisements to end users of computer systems.

According to a specific embodiment, at least some of the Topic Expansion/Self Learning optimization techniques described herein may be operable to leverage Taxonomy Database information in order to perform one or more of the following: make “advertising related” connections between subjects; display ads based on those related subjects; measure performance; and/or optimize yields automatically over time. Further this process may be adapted to run automatically in real time and to allow at least some of the dynamic contextual markup techniques described herein to offer related and competing products and/or services that might interest the user that is interacting with specific content. For example, for a selected web page that discusses advantages relating to new anti virus software programs, it may be desirable to might utilize topics such as, for example: personal firewall, desktop computers, and/or email spam blocking, even though these topics might not be directly related to the selected web page's content.

FIG. 5C shows a block diagram representing a specific embodiment of portion of taxonomy information 557 which, for example, may be stored in a taxonomy database. The specific example of FIG. 5C is used to illustrate a case where a first grouping 551 of topic and subtopics have been determined to be a “best” match for a page based on relevancy score, for example. Using one or more of the Topic Expansion/Self Learning optimization techniques described herein, additional terms for the adjoining topics and/or subtopics may be used over time for complementary offerings.

Another aspect is directed to various techniques for improving the accuracy of predicting which terms, keywords, and/or ads will perform well for a given set of circumstances (e.g., for a specific webpage or website). In one implementation, good performance may be defined as ads which: are well accepted by users; generate a minimum or desired click-through-rate; and/or maintain an acceptable cost-per-acquisition rate for the advertiser.

In an online landscape that operates 24/7/365 with content that changes very frequently, ad feeds that react to a real time bidding market, and user patterns that change from site to site, it is desirable for a contextual analysis and advertising solution to “correct” itself over time and automatically improve the interaction and overall results for all three entities: users, online publishers, and advertisers.

In one embodiment, these objectives may be achieved, for example, by employing a novel self learning optimization system that runs a dynamic statistical model which compares the performance of terms (topics and keywords) on one or more levels such as, for example: global, publisher, page.
Global: comparing the performance of terms in relation to all users that viewed similar content.
Publisher: comparing performance for similar content for a single publisher.
Page: comparing performance for the specific page.

According to a specific embodiment, the system may initially begin with the global perspective, and as more data becomes available, may then dynamically and automatically adapt by focusing down to the publisher, page levels in order to make the ads selections more precise.

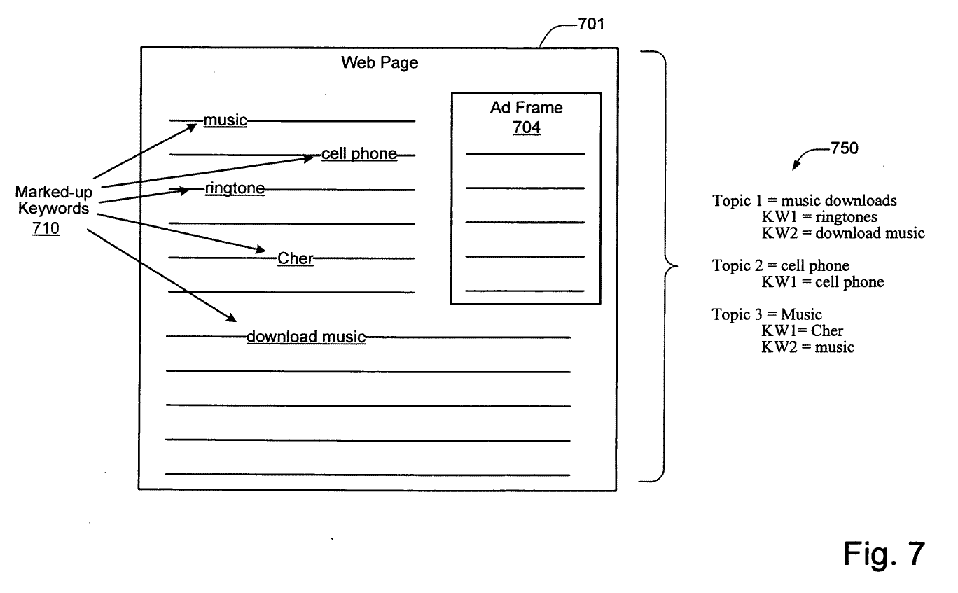

FIG. 7 shows an example of a web page 701 which may be used for illustrating various aspects of one or more techniques described herein. In this example, it is assumed that web page 701 includes textual content to be displayed to the user. It is further assumed in this example that the web page content has been analyzed for topics and keywords (KWs) and that selected keywords 710 have been marked up or converted into ContentLinks.

For example, as shown at 750, a topic/keyword analysis has identified at least three topics relating to the content of webpage 701:
Topic 1=music downloads
Topic 2=cell phone
Topic 3=Music

Further, as illustrated, various keywords have been identified from the webpage content relating to each topic:

Topic 1=music downloads
KW1=ringtones
KW2=download music
Topic 2=cell phone
   KW1=cell phone
Topic 3=Music
   KW1=Cher
   KW2=music

Although not illustrated, other topics and keywords relating to the webpage content may also be identified.

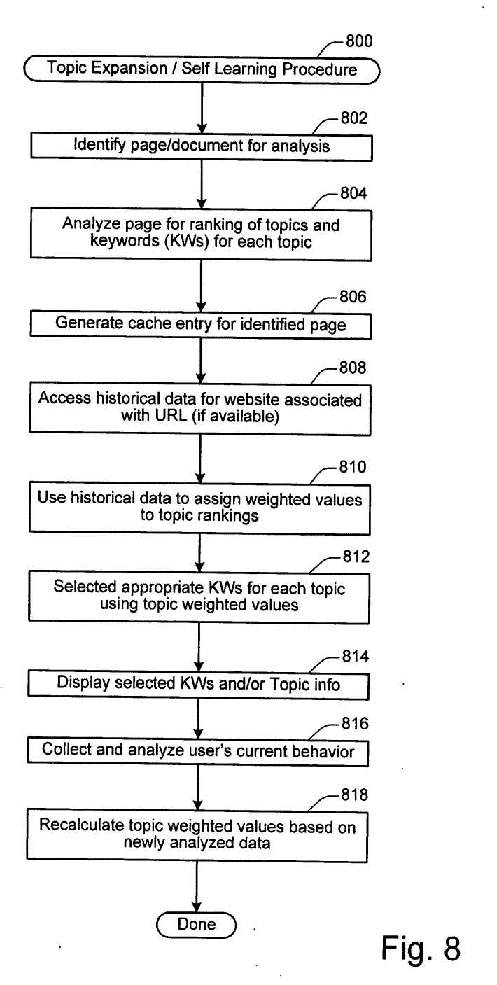

FIG. 8 shows a flow diagram of a Topic Expansion/Self Learning Procedure 800 in accordance with a specific embodiment. According to a specific embodiment, at least a portion of the Topic Expansion/Self Learning Procedure 800 may be implemented at the Kontera Server System.

At 802 a document or page (e.g., webpage) is identified for analysis.

At 804, the page is analyzed for ranking of topics and keywords (KWs) for each topic. In one implementation, at least a portion of this analysis may be implemented using one or more content analysis techniques described or referenced herein.

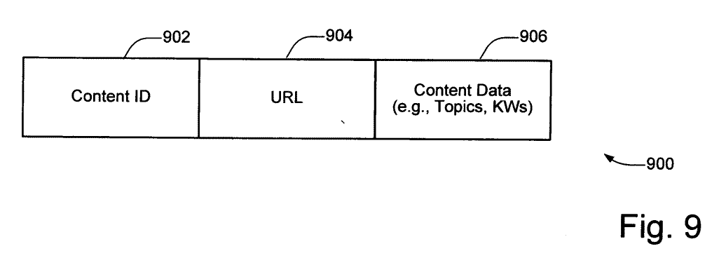

At 806, a cache entry for the identified page may be generated and populated using at least a portion of information derived from the webpage analysis. An example of a cache entry for a webpage is shown in FIG. 9. In this example, the cache entry includes various information which, for example, may include, but is not limited to, one or more of the following (or combination thereof):
Content ID (902)—This is a unique key (e.g., characters, numbers, etc.) that may be generated from a portion of the content's text. The portion may be based on a specific percentage of the text (e.g., how much text to use for generating this key). In one implementation, this percentage may be configurable.
Associated URL (904) such as, for example, URL associated with an identified webpage.
Content data (906) such as, for example, identified topics and/or keywords associated with the identified webpage.

Returning to FIG. 8, at 808, historical data which relates to the website associated with the URL (of the identified webpage) may be accessed (if available). According to a specific embodiment, such historical data may include, for example, information about one or more of the following:
information about how users have previously interacted with keywords (e.g., previously marked-up KWs) from specific topics associated with that website;
information about user behaviors for different topics associated the website (e.g., which topics/KWs generated the most user interactions);
etc.

At 810, at least a portion of the historical data may be used to assign weighted values to various topics and/or topic rankings. For example, according to one implementation, weighted values (e.g., percentages) may be used to determine the relative number of KWs to be highlighted for each different topic.

As 812, the assigned weighted values may be used to select one or more appropriate KWs for each topic or for selected topics meeting certain criteria (e.g., top 3 highest ranking topics for that page). For example, if it is assumed that a maximum of 10 KWs are allowed to be highlighted on selected page, and that the assigned weighted values are: Topic 1=50, Topic 2=20, Topic 3=80, then, according to one embodiment, 5 KWs may be selected from Topic 1, 2 KWs selected from Topic 2, and 3 KWs selected from Topic 3.

At 814, the selected KWs and/or Topic info may then be marked up or highlighted as shown, for example, in FIG. 7.

Once the selected KWs and/or Topic info has been marked up on the webpage display, and displayed to the user, the user's behavior(s) (e.g., actions taken in response to the highlighted KWs/Topic info) may be collected and analyzed (816).

At 818, recalculation of the topic weighted values may be performed based, at least in part, on newly analyzed data. For example, using one technique, better performing KWs may be selected more often for future ContentLink operations.

In one embodiment, such analysis and/or calculations may be implemented in real-time (or near real-time) in order allow the Kontera Server System (and/or other systems) to automatically and dynamically adapt, in real-time, its algorithms and/or other mechanisms for topic/keyword identification and selection.

Additionally, at least some embodiments of the Topic Expansion/Self Learning optimization techniques described herein may be applied to situations where selected KWs are not located in the content of the page or document.

For example, using the example shown in FIG. 7, at least some embodiments of the Topic Expansion/Self Learning optimization techniques described herein may be applied to content in Ad Frame portion 704, which, for example, may be used for displaying advertisements (or other information) that is not included as part of the original content of webpage 701. Moreover, the information in Ad Frame portion 704 may dynamically change with each refresh of the URL. In at least one implementation, it is also possible to display ads directly based on keywords and/or topics identified in the Ad Frame portion 704. In one implementation, performance of a keyword may be based, at least in part, on how many clicks are generated for the associated ad.

The following disclosure describes various embodiments for implementing techniques for facilitating improved page context advertisement selection techniques in advertising environments such as those employing contextual in-text keyword advertising techniques for displaying advertisements to end users of computer systems.

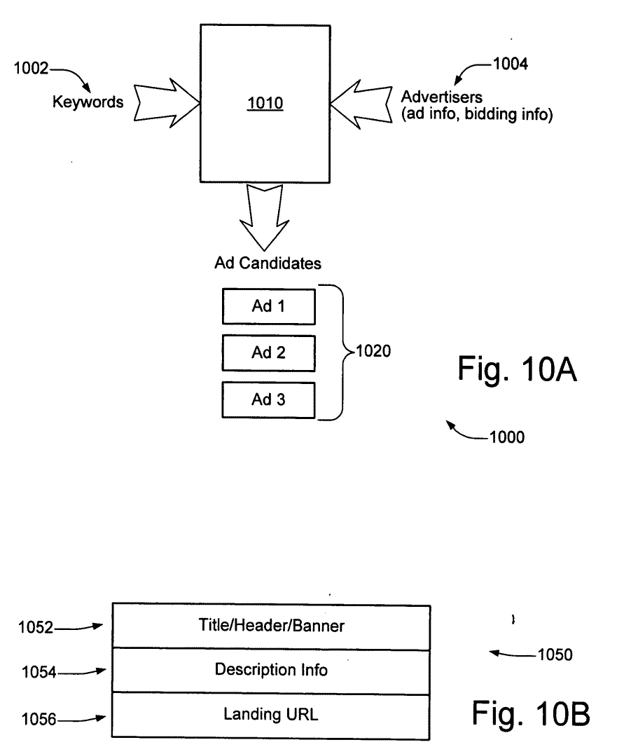

FIG. 10A illustrates an example of one embodiment which may be used for obtaining one or more ad candidates 1020 to be considered for use as ContentLinks and/or other advertising purposes for a given web page or document. In the example of FIG. 10A, it is assumed that a selected web page has been analyzed for keywords and/or topics using, for example, one or more of the contextual analysis techniques described or referenced herein.

Selected keywords 1002 which have been identified are provided to server 1010, which is adapted to facilitate selection of potential ad candidates based upon various input parameters such as, for example: keyword data 1002 (e.g., provided by Kontera Server System) and advertiser information 1004 (e.g., ad information, bidding information, etc., which may be provided by one or more advertisers). In one implementation, at least a portion of the functionality of server 1010 may be implemented by the Kontera Server System. In one embodiment, server 1010 may be adapted to utilize the keyword data and advertiser information to generate one or more potential ad candidates 1020.

FIG. 10B shows an example of various types of information which may be included with an ad candidate. For example, the ad candidate may include title/header/banner information 1052, ad description information 1054, landing URL information 1056, etc. According to a specific embodiment, the landing URL information may include a URL specified by the advertiser. When a user clicks on the advertiser's ad, the user's browser will be redirected to the web page corresponding to the landing URL associated with that ad.

One problem a which may occur using this advertisement selection technique is that one or more of the ad candidates may not actually be relevant to the context of the web page for which the ad is to be used or placed. For example, if the keyword “phone” were input to server 1010, this keyword may retrieve several different ad candidates relating to different contexts for the keyword “phone.” A first ad candidate may be related to a cell phone ad, a second ad candidate may be related to an IP phone ad, a third ad candidate may be related to an ad for long distance rates.

Accordingly, another aspect is directed to various techniques for providing improved mechanisms for ad selection which result in an improved contextual match between the web page content (displayed to the user) and the content of the advertiser's site and/or landing URL page.

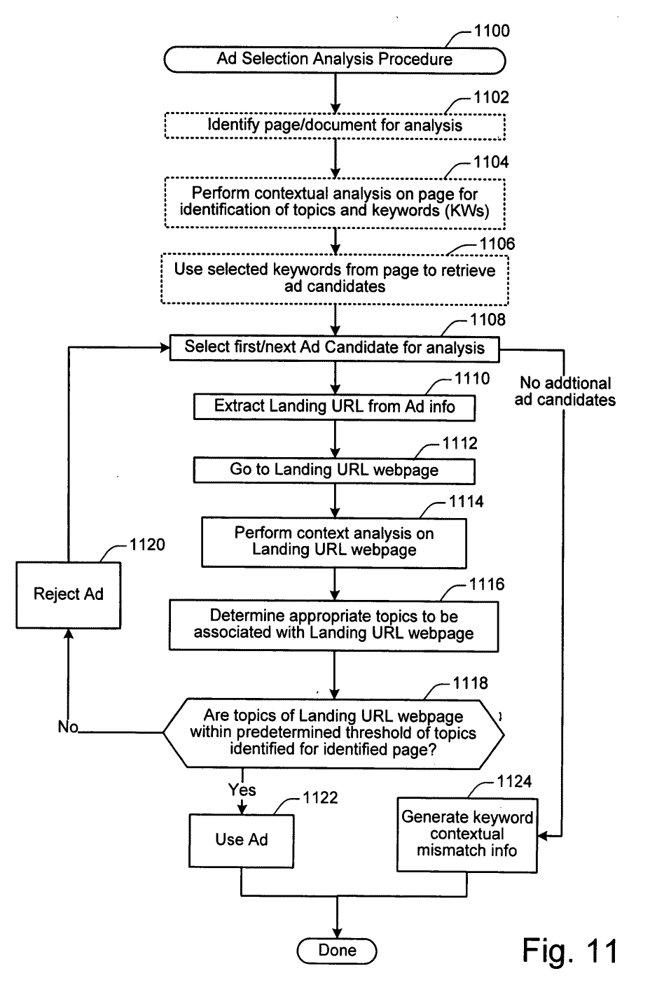

FIG. 11 shows a flow diagram of an Ad Selection Analysis Procedure 1100 in accordance with a specific embodiment. In at least one implementation, at least a portion of the Ad Selection Analysis Procedure 1100 may be implemented by the Kontera Server System.

At 1102 it is assumed that a document or page (e.g., web page) has been identified for analysis.

At 1104 contextual analysis may be performed on the identified page for identification of topics and/or keywords. In one implementation, at least a portion of this analysis may be implemented using one or more content analysis techniques described or referenced herein.

At 1106 at least a portion of the identified keywords may be used to retrieve one or more ad candidates. For example, in one implementation, as described previously, at least some of the identified keywords may be provided to server 1010, which may then perform a query using the input keywords, and provide an output of one or more potential ad candidates.

At 1108 a first (or next) had candidate is selected for analysis.

At 1110, the landing URL for the selected ad candidate may be extracted or identified.

At 1112, the landing URL web page (e.g., corresponding to the landing URL) is accessed.

Content and/or contextual analysis of the landing URL web page content may be performed (1114), for example, in order to determine or identify (1116) one or more topics which are associated with the landing URL web page content.

At 1118 a determination is made as to whether the topics identified as being associated with the landing URL web page are within a predetermined threshold of topics identified for the identified web page (e.g., the webpage identified at 1102), according to specified criteria. For example, in one implementation, the predetermined threshold may be satisfied if it is determined that at least one of landing URL web page topics matches one of the top 5 ranked topics associated with the identified web page.

If it is determined that the topics identified as being associated with the landing URL web page are within a predetermined threshold of topics identified for the identified web page, the selected ad candidate may be used 1122. If, however, it is determined that the topics identified as being associated with the landing URL web page are not within a predetermined threshold of topics identified for the identified web page, the selected ad candidate may be rejected 1120, and a next ad candidate selected (1108) for analysis.

According to specific embodiments, if none of the potential ad candidates are determined to be usable, then an event may be triggered in which keyword contextual mismatch information is generated. In one implementation, at least a portion of the keyword contextual mismatch information may be stored at the Kontera Server System, and may include information relating to the fact that the potential ad candidates which were selected based on the selected keyword(s) do not match the context of the identified webpage. The keyword contextual mismatch information may also include other information such as, for example:
timestamp data;
keyword(s);
identified page URL;
landing URL(s);
topic information;
etc.

Another technical challenge involved in the design of the on-line contextual advertising techniques relates to the selection of the keywords in the document content to be highlighted as hyperlinks with ads, and to the selection of the most desirable ad to be linked with each keyword (if there is a choice). According to specific embodiments, when selecting advertisements to place on keywords in a page, it may be desirable to consider both ad revenue and ad relevance (e.g., in terms of maximizing or optimizing one or both, for example). Thus, for example, while ad revenue may provide short-term benefit to both the contextual advertising service provider (e.g., Kontera) and the publisher, ad relevance can be seen as a benefit to the user, thereby creating long term value for Kontera and the publisher by engendering user acceptance and trust of the service. The number and density of highlighted keywords on a particular web page may also affect the user experience, and thus have a long term impact on revenue and/or services relating to the contextual advertising service provider.

According to specific embodiments, at least some on-line contextual advertising technique(s) described herein may be configured or designed to dynamically and automatically implement self-improvements, reconfigurations, and/or modifications made by reacting to the performance as measured in careful experiments. It may be appreciated that various operations may be performed for adapting or modifying a conventional context-based advertising systems to include additional features such as those described or referenced herein. Examples of such operations may include, but are not limited to, one or more of the following (or combination thereof):
Create training and testing data sets to be used for the training and evaluation of click through rate (CTR) estimation systems.
Create a small testing data set containing human annotations for the relevance estimation task, so that one can compare the performance of an existing relevance system to a simple baseline which compares feature vectors.
Develop and test a simple CTR estimation system based on the interpolated back-off counts with only a few buckets. Learn the mixing weights for use with Expectation Maximization (EM) algorithms, and tune the strength of the prior β by manual and/or automated processes.
Build an ad selection and layout system.
Exploration system doing random selection of ads that aren't being displayed. Integrate it into the ad selection system.
Use feature-based and topic-based relevance estimation systems Developing the topic-based system may include training statistical classifiers such as Naive Bayes, SVM and Logistic Regression.
Build CTR estimation system using a logistic classifier.
Build exploration system, which prioritizes the pages to explore based on the value of the information that can be gained.

At least a portion of the above-described operations or processes are described in greater detail below.

In developing a system design, it may be useful to decompose the ad placement problem into a small set of relatively independent subproblems. Because ad selection decisions are based on the relevance and expected revenue of the ads themselves, the accurate estimation of these quantities pose obvious subproblems. In the ad relevance estimation it may be desirable to use features of the web page, as well as features of the ad (and possibly the target page it links to) to estimate the relevance of the ad to the group of users viewing the page. In the click-through rate estimation it may be desirable to attempt to estimate the probability that an ad may be clicked on, before a choice is made whether or not to display it. As described in greater detail below, in at least one embodiment, these CTR estimates may be combined in a straightforward way with cost-per-click estimates to obtain expected revenue for each ad.

A third subproblem is that of the advertisement selection and layout itself. For example, after obtaining estimates of the relevance and expected revenue of every possible (or specifically selected) keyword/ad pair(s) on the page, it may be desirable to choose a subset of these ads to actually display to the user. In doing so, it may be preferable to optimize a complex function of the relevance, revenue, and layout of each subset. This is challenging for two reasons. First, in at least some embodiments, it may be necessary to balance these objectives against one another (e.g., to improve relevance we may need to sacrifice revenue, or viceversa). Second, the space of keyword/ad pair subsets is very large (exponential in the number of possible keyword spans on the page), so it may be hard to find the high-scoring subsets.

Another subproblem to be addressed is that of balancing exploration and exploitation. For example, one approach is that it may be preferable to display only the keyword/ad pairs that are known to be “good” (e.g., relevant and high-revenue). For example, a numerical threshold could be used (e.g., based on a calculation taking into account both relevance and estimated revenue, weighted as desired) may be used in determining whether a given keyword/ad pair is considered “good”. Alternatively, one or more scoring functions may be used to generate relative scores which may then be used as a basis of comparison against other options. However, some opportunities may be missed with such policies. For example, new ads and new pages appear in the system all the time, and without trying new ad/keyword/page combinations in front of real users, we may miss valuable revenue opportunities. For this reason, it can be very useful to also explore ads and pages about which we have less information. As described in greater detail below, several techniques are proposed for balancing these two objectives.

FIG. 12A shows a block diagram of a portion of a Kontera Server System 1200 in accordance with a specific embodiment. At least a portion of the functionality of each of the displayed components of the Kontera Server System portion 1200 is described below. It will be noted, however, other embodiments of the Kontera Server System may include different functionality than that described with respect to FIG. 12A.

According to specific embodiments, the EMV Engine (e.g., 1202) may include various types of functionality which, for example, may include, but are not limited to, one or more of the following features (or combination thereof):
generating estimates of various parameters, such as, for example, the Expected Monitory Value for specified Page, Highlight, and/or ad combinations;
providing analysis and/or tracking operations;
learning user behaviours for facilitating increased accuracy of estimates such as, for example, EMV estimates;
generating back-off estimates;
providing Logistic Regression operations;
etc.

According to specific embodiments, the Relevance Engine (e.g., 1204) may include various types of functionality which, for example, may include, but are not limited to, one or more of the following features (or combination thereof):
identifying and/or selecting ads that are relevant to the content of a selected page;
providing analysis operations;
generating ad and/or page classifier data;
generating ad relevancy scores;
etc.

According to specific embodiments, the Layout Engine (e.g., 1208) may include various types of functionality which, for example, may include, but are not limited to, one or more of the following features (or combination thereof):
identifying and/or selecting highlights (e.g., keyword highlights) to be displayed;
generating ad rankings;
providing reaction operations;
etc.

According to specific embodiments, the Exploration Engine (e.g., 1206) may include various types of functionality which, for example, may include, but are not limited to, one or more of the following features (or combination thereof):
exploring ads that may yield better values (e.g., better revenues) than current ads;
interacting with layout engine, for example, to understand and/or to identify highlight candidates for further exploration;
providing tracking and/or reaction functionality;
etc.

According to specific embodiments, the Data Analysis Engine (e.g., 1210) may include various types of functionality which, for example, may include, but are not limited to, one or more of the following features (or combination thereof):
collecting and/or analyzing user behaviour information;
tracking ad impression information;
etc.

FIG. 12B shows a high level architecture of a specific embodiment of an on-line contextual advertising system in accordance with a specific embodiment. At illustrated, one component of the system includes an ad Layout Module (1260), which selects a set of highlight/ad pairs to display on each page. To make this decision, the ad Layout Module may utilize estimates of the relevance of the ad to the page, as well as its expected monetary value. In one embodiment, these estimates may come from the ad Relevance Estimation (1252) and/or CTR Estimation (1254) modules.

According to a specific embodiment, Click-through rate (CTR) estimation refers to the statistical estimation of the probability that a user will click on a certain ad in a certain context.

Once the page has been displayed, and the user action recorded, this information may be added to the current counts of impressions, clicks (and/or possibly mouseover events) maintained by the Counts Module (1258), and used by the CTR Estimation Module and/or other desired modules to make estimates.

Additionally, an Exploration Module (1256) makes decisions about which ads are worth exploring, and sends these recommendations to the Ad Layout Module 1260, so that the exploration ads can be included in the layout. Additionally, to make this decision, the Exploration Module may need to obtain information about which ads are already being displayed, and what kind of change in the estimates of an ad would be required in order to make the ad worth including in the layout. In one embodiment, at least a portion of this information may be provided by the Ad Layout Module.

According to a specific embodiment, the CTR estimation system may be operable to generate real-time CTR estimates or predictions based on historical data relating to the live or on-line system, which may be continually and dynamically changing.

However, because system development experiments based upon live system data would not be repeatable, in at least one embodiment, it is proposed to “freeze” some data sets as a snapshot of the system at a particular point in time for the development systems to run on and/or be tested. This technique may also be useful for the training procedures that may be required by some parts of the system.

According to specific embodiments, each data set may include counts of the number of impressions and number of clicks of particular page/highlight/ad combinations over a specified period of time. For example, in one embodiment, three such data sets are used, which, for example, may include: a training set, a held-out set, and a test set. In one embodiment, it may be preferable that these sets be drawn from temporally contiguous time periods. For example, if the training set is created from counts over the period January to March, then the held-out set should preferably include the month of April, and the test set should preferably include the month of May. In another embodiment may be preferable that the data sets do not overlap temporally. This is explained, for example, in greater detail below with respect to the EM training feature(s). In at least one embodiment, the time period of the training set should preferably be long enough to include significant numbers of impressions for each combination (e.g., more than a day). However, the held-out and test sets may be significantly smaller. In one embodiment, the data sets may include statistics about as many page/highlight/ad combinations as possible. For example, if feasible given computing and storage constraints, it may be desirable to use all impressions detected in the system over a specified time period.

Using the training, held-out, and test sets, one is then able to perform rigorous, quantitative evaluations of the complete CTR estimation system. For example, in one embodiment, one or more of the models may be trained, for example, using the training and held-out sets, and subsequently used to predict the click stream that is observed in the test set. This mirrors the process that may occur when the CTR estimation model is integrated into the production system, and so will serve as a good measure of its performance.

### ESTIMATION OVERVIEW AND EXAMPLES

Consider an ad a served at a highlight h of a keyword k on a page p. We would like estimate the probability P(c=1|a, h, p) that this ad will be clicked (c=1) by the user during the next page display. There are several sources of information for this task. The basic source is the local counts of the number of impressions (e.g., how many times this ad was displayed on this exact highlight of a keyword on this exact page) and of those ad impressions, how many times it was clicked. Given enough counts of the particular page/highlight/ad combination, we will eventually have a good idea of its empirical CTR, which, for example, may be computed according to:

$$\hat{P} ( c = 1 \vert p , h , a ) = \frac{\# ( c = 1 , p , h , a )}{\# ( p , h , a )}$$

However, if the total number of impressions of this particular page/highlight/ad combination is too small, this is likely to be an inaccurate, or noisy estimate of the true CTR. For example, if the CTR is less than 0.1%, we are not likely to see any clicks in the first 100 impressions, which would make the CTR estimate zero. For this reason, it may be preferable to use evidence from similar events to provide estimates. We will call such estimates back-off estimates, since they are constructed from “backing off” from the most specific counts to counts in more general classes.

In any particular case, it may be desirable to combine the local counts with one or more back-off estimates in such a way that a system according to example embodiments may use the back-off estimate(s) when the local counts are low, and uses the local counts increasingly as they become larger. A natural way to do this is to use the back-off estimate(s) as a prior distribution which may be updated by the empirical counts. This may result in desired behavior such that, as the empirical counts grow larger, they eventually overwhelm the prior. In particular, we can use the back-off model to form a Dirichlet prior so that the maximum a posteriori (MAP) estimate of the distribution takes the following form:

$${P}_{CTR} ( x = 1 \vert p , h , a ) = \frac{\# ( c = 1 , p , h , a ) + β {P}_{BO} ( c = 1 \vert p , h , a )}{\# ( p , h , a ) + β}$$

In one embodiment, the above expression may be used to calculate an estimate of CTR. The parameter β corresponds to a free parameter which may be determined and/or tuned either manually or automatically. If β is too large then the CTR model will not be impacted by the presence of the empirical counts, even if those counts are large enough to provide reliable estimates of the CTR. If β is too small, then even small (noisy) amounts of counts will lead to changes in the estimated CTR. Since most actual CTRs in the system are less than 0.001, one might suggest that a good value for p would be at least 1000.

According to a specific embodiment, it is preferable that the back-off estimate(s) be computed based on a mixture of different empirical estimates, each made from the counts of a particular abstracted comparison classes. For example, possible back-off estimates include but are not limited to the following:
\hat{P}(c=1|t(p),h,a), which represents the probability of a click occurring given the specific topical class of the specific web page, specific highlight, and specific ad;
\hat{P}(c=1|s(p),h,a), which represents the probability of a click occurring given the specific website, specific highlight, and specific ad;
\hat{P}(c=1|p,k(h)), which represents the probability of a click occurring given the specific web page, and specific keyword;
\hat{P}(c=1|p,a), which represents the probability of a click occurring given the specific web page, and specific ad;
\hat{P}(c=1|k,a), which represents the probability of a click occurring given the specific keyword, and specific ad;
\hat{P}(c=1|a), which represents the probability of a click occurring given the specific ad;
\hat{P}(c=1|k(h)), which represents the probability of a click occurring given the specific keyword;
\hat{P}(c=1|t(p)=t(a)), which represents the probability of a click occurring given that the topical class of the specific web page matches the topical class of the specific ad;
\hat{P}(c=1), which represents the probability of a click occurring for all topical classes, web pages, highlights, keywords, etc;

where:

t(p) is the topical class of the page p,

s(p) is the website that p is a part of;

k(h) is the keyword occurring at highlight h.

In one embodiment, the last estimate may represent the system-wide ad CTR, which may include no specific information about the page, keyword, or ad.

According to a specific embodiment, the mixture weights may be learned on temporally contiguous held-out data using an Expectation-Maximization (EM) algorithm. An example of the form of the linear interpolated back-off estimate is:

$${P}_{BO} ( c \vert p , h , a ) = {\sum }_{i} {α}_{i} {P}_{i} ( c \vert {Evidence}_{i} ) \qquad ( 1 )$$

where αᵢ are respective positive weights summing to one, and each Pᵢ(c|Evidenceᵢ) is a particular back-off class or back-off estimate such as, for example, one of those described above. According to a specific embodiment, each αᵢ may be statically or dynamically calculated for a given Evidenceᵢ.

According to a specific embodiment, the Expectation-Maximization (EM) algorithm can be used to learn the weights αᵢ above. One first initializes these weights to 1/B where B is the number of comparison classes being mixed together. Using these preliminary weights, one iterates through each held-out record (p, k, a, c) and calculates the posterior distribution over which mixture generated each record, according to:

$$P ( i \vert p , k , a , c ) = \frac{{P}_{i} ( c \vert p , k , a )}{{\sum }_{j} {P}_{j} ( c \vert p , k , a )}$$

The new mixing weights are the normalized sum of these posteriors:

$${α}_{i} ∝ {\sum }_{( p , k , a , c )} P ( i \vert p , k , a , c )$$

According to a specific embodiment, the α indicates that the αᵢ may be renormalized to sum to one. This process of calculating posteriors and updating weights is iterated until convergence.

According to at least one embodiment, it is preferable that the held-out set be temporally distinct from the training set, since, for example, if we tried to learn these parameters from the training set, the most specific comparison classes would receive all the weight, and little generalization would occur.

Another valuable source of information in CTR estimation is whether or not the user put his mouse over a particular highlight on the page. This event is typically referred to as a mouseover. The intuition here is that the decision to mouse over a link is conditioned only on the highlighted keyword, and is not affected by the contents of the ad, since, according to at least some embodiments, the ad was not visible at the time of the decision or mouseover action. Also, the CTR estimates of the ad are likely to be much higher if they are conditioned on the mouseover since presumably, most highlights are never moused over.

Incorporating this information properly, it may be preferable to include a small change to one or more of the model(s) proposed above. For example, if we use (m=1) to represent the mouseover event, then we can factor the probability distribution as:

$$\begin{matrix}P ( c = 1 \vert p , h , a ) = {\sum }_{m} P ( c = 1 \vert p , h , a , m ) \cdot P ( m \vert p , h ) \\ = P ( c = 1 \vert p , h , a , m = 1 ) \cdot P ( m = 1 \vert p , h )\end{matrix} \qquad ( 2 )$$

The first line stems from introducing the variable m and conditioning on it, and the second line is created by dropping the term in the sum for m=0 because the probability of a click is 0 if the mouseover doesn't happen.

Thus, for example, we see that the probability of a click on a particular highlight is the probability of a mouseover times the probability of a click given a mouseover. So we have two quantities to estimate now, instead of one. According to a specific embodiment, each can be estimated using at least one of the models described herein such as, for example, by using a combination of local counts and a back-off mixture model. In one embodiment, such models may be combined using maximum a posteriori (MAP) estimation with a parameter β giving the strength of the prior that can be tuned either manually or automatically, and each of the back-off mixtures has weights that can be learned (e.g., separately) by EM, for example.

Although there are now two quantities to estimate, there is reason to believe that we have actually made our problem easier. For example, the mouseover probability conditions only on the page and the highlight, but not on the ad. To estimate this quantity we may use counts from fewer categories, and each category is likely to contain more counts. Additionally, the click probability conditions on the fact that there was a mouseover, and is likely to be a larger probability, thus requiring few counts overall to estimate properly.

According to specific embodiments, the back-off model may be used to generate accurate and/or efficient estimates, but may not allow for the exploitation of more general features of keywords and advertisements, such as, for example, whether the keyword is capitalized, whether the ad text ends in an exclamation point, whether the keyword occurs in the page title, and so on.

Logistic Regression

Accordingly, in at least one embodiment, a more sophisticated approach may be to utilize a feature-driven logistic regression model. In this approach, general features alone may be used to predict the CTR. Examples of such general features may include, but are not limited to, one or more of the following (or combination thereof):
whether the keyword is capitalized;
whether the ad text ends in an exclamation point;
whether the keyword occurs in the page title;
length of ad
length of keyword;
length of page;
position on page;
structure of page;
other ads on page;
type of ad;
html elements;
whether keyword is bold;
font of ad;
etc.

According to a specific embodiment, it may also be preferable for a feature of the logistic regression model to include a log-probability of one or more back-off estimate(s), which, for example, were derived using one of the back-off estimate models described above. In this way, the other features are then able to provide multiplicative correction to the base count-driven estimates. For example, one embodiment of a logistic regression model may be expressed as:

P(c=1|p,h,a)≈LR_{ƒ(i)}[EMᵢ+λᵢFeaturesᵢ] (3)

where LR_{ƒ(j)} represents a logistic regression function, EMᵢ represents one or more EM-based estimates (which may include one or more back-off estimates), Featuresᵢ represents one or more general features (such as those described above) and λᵢ represents a respective weighted value for each Featuresᵢ parameter.

According to a specific embodiment, the task as we have defined it is one of regression, not classification. In one embodiment, the model and training procedure may be substantially similar to the logistic regression model used for classification. For this reason, it may be possible to use an existing logistic regression classifier, such as one provided in classification software packages such as, for example, Rubryx (available from www.sowsoft.com/rubryx/about.htm).

It will be appreciated that another aspect of at least some of the various technique(s) described herein relates to the use, in the field of on-line contextual advertising, of EM parameters and/or back-off estimate parameters as features in logistic regression computations for improving CTR estimation.

According to specific embodiments, a variety of different architectures may be used for implementing logistic regression techniques in accordance with various embodiments. For example, according to one exemplary architecture, one can learn a logistic model for each comparison class in the back-off lattice and mix those models. In another exemplary architecture, one can wrap a single logistic model around the interpolated lattice.

It is anticipated that the patterns of which ads and keywords are most popular will change over time. There is therefore a tension between wanting as many observations as possible, and wanting those observations to be as recent (and therefore relevant) as possible. One effective and tunable way to trade off these extremes is to discount counts with age. A simple way to do this is with an exponential decay of counts, perhaps in time steps of days, weeks, or other specified time periods. A rapid rate of decay may be used to maximize relevance, whereas a slow rate of decay may be used to maximize available evidence. An alternative solution would be to use only a fixed number w of the most recent impressions in building estimates.

Relevance Estimation

According to at least one embodiment, at least some of the various technique(s) described herein relating to relevance estimation (RE) addresses the issue of estimating the relevance of a prospective keyword/ad pair to a particular page. In at least one embodiment, the term relevance may refer to an informal notion of the relatedness between the text on the source page and the text in the keyword, ad, and/or the ad's target page. We may wish to assess relative relevance (e.g., so that we might be able to rank possible keyword/ad pairs for their relatedness) and/or to assess absolute relevance (e.g., so that we could filter out ads which are deemed too irrelevant).

In designing a relevance estimation system, it may be preferable to develop a general way of measuring the performance (e.g., accuracy) of a relevance system.

One way to assess textual relatedness of two documents is to convert each of the documents to a featural representation, and then to compare these representations quantitatively. Typically the featural representations are vectors of real numbers, which can be compared using various metrics.

One featural representation of a text document is the vector of word (token) counts contained in the document, where the vectors for different documents are indexed by the same list word types. There are a few tricks, however, to building featural representations which capture similarity well. For example, it is often useful to remove extremely common words, often called stopwords, from the representation completely. Lists of stopwords are usually built by hand but are very easy to come by on the Internet. A more sophisticated approach is to weight different features differently. Instead of token counts, another approach is to use the TFIDF (term frequency, inverse document frequency) measure, which discounts terms that are common to many documents:

$$tf = \frac{c ( t , d )}{c ( \cdot , d )}$$

$$idf = \frac{\vert D \vert}{\vert \{ d : c ( t , d ) > 0 \} \vert}$$

$$tfidf = tf log idf$$

Additional features that could be added to the representation include counts of bigrams (contiguous pairs of tokens), counts of word shapes (capturing capitalization, etc.), web page formatting and layout information, and/or other global features of the document, such as length, title, etc.

One metric for comparing vectors is the dot product. This has a desirable property that when the vectors are perpendicular (unrelated) the dot product is 4), and when they are parallel the dot product is maximized (it is the geometric mean of the lengths of the vectors). When it is properly normalized, the dot product is equal to the cosine of the angle between the vectors, which is Φ when the vectors are perpendicular, and 1 when they are parallel.

$$cos ( Φ ) = \frac{x \cdot y}{\vert x \vert \vert y \vert}$$

In at least some embodiments, it can be useful to work with both the cosine and the unnormalized dot product. For example, while the latter is sensitive to the length of the vectors (the number of words in the documents), the former can behave strangely with short documents.

While it is often convenient to think of documents as just vectors of feature counts, this conception often doesn't work well at capturing similarity. In particular, small differences in word counts near zero can have a large impact on similarity (whether a particular word was mentioned at all, for example), but in a dot product the differences near zero are treated identically to those that are far from zero.

One way to address this phenomenon is to view the vectors instead as probability distributions over the words generated by the documents. According to a specific embodiment, when viewed this way, a more appropriate way to measure the relatedness of two documents may be to compute the Kullback-Leibler (KL) divergence between their associated probability distributions:

$$KL ( p \vert \vert q ) = {\sum }_{x} p ( x ) log \frac{p ( x )}{q ( x )}$$

KL-divergence can be thought of as a measure of the difference between the entropy of a distribution p, and the cross entropy of p and q. Informally, it measures the relative “cost” that would be incurred if we were to try to use the distribution q to represent the distribution p, instead of using p itself.

Although the use of KL-divergence may be desirable in some circumstances, other circumstances may make its use undesirable. For example, when q assigns zero probability to an event (e.g., Event X) which p assigns positive probability to, the KL divergence goes to infinity.

Statistical Classifiers

Instead of directly computing the similarity between two text documents, an ontology of document classes (e.g., either learned or hand-coded) could be used to assign each document a class, and see whether or not the two documents belong to the same class. More generally, one could compute for each document a distribution over the classes that the document could belong to, and compare the class distributions of two documents to measure their similarity.

One advantage of the class-based approach is that it can be used to give absolute assessments of relevance. An example of one way to do this is via a rule which says that documents are relevant if they are assigned to the same class. A different approach would be to compare the class distributions computed for each document using one or more similarity metrics (such as those described previously, for example), and consider the documents to be relevant if the score is above a predetermined threshold.

Statistical classifiers are tools that have been designed specifically for the purpose of assigning class labels to a document, and/or (for some classification methods) computing distributions over possible classes for a document. Such classifiers can be learned directly from training data, and in many cases can make very accurate decisions.

According to a specific embodiment, it may be preferable to use a Naive Bayes statistical classifiers model, since it is high bias and robust to noisy real-world data. However, it would still be good to experiment also with either multiclass logistic regression (also called a maximum entropy or log-linear model), with quadratic priors for normalization, and/or with multiclass support vector machine (SVM) models.

According to a specific embodiment, one way to classify a document into a set of topic classes is to use a multiclass classifier in which each topic is a class. This method is appropriate if we expect each document to have a single topic class. If, instead, each document may be labeled with a variable number of relevant topics, then it may be more effective to instead build a separate binary classifier for each topic; this may be referred to as one vs. all classification. This approach allows zero, one, or multiple topics to be detected on a single document.

Latent Semantic Measures

One drawback of the class-based approach is that it may require the use of a supervised (e.g., manually edited) training set of examples to train a statistical classifier that can be used to assign class labels. In some cases, unsupervised techniques such as latent semantic analysis (LSA) can also work well, without the need for manually edited examples. LSA is an application of matrixfactorization techniques, in which the matrix in question is indexed by documents and terms, and the elements contain a representation of the magnitude of the occurrence of a particular word in a document. Many LSA variants exist, including the LSA technique based on the Principal Components Analysis (PCA) algorithm from linear algebra, as well as Probabilistic Latent Semantic Indexing (pLSI), the Latent Dirichlet Allocation (LDA), and Non-negative Matrix Factorization techniques. They vary in both efficiency and solution quality.

In one embodiment, the LDA approach is recommended because it has a firm probabilistic foundation. Another advantage of using a system like LDA to assign topics to pages is that it is designed to allow each document to draw words from several topics.

Ad Layout

According to specific embodiments, one objective of an ad selection and layout system is to select a subset of the possible keywords and ads to display on a particular page and then to lay them out in a way that maximizes both readability and expected monetary value. To accomplish this, it is helpful to formalize the notion of a “good” layout as a scoring function, and then search over the space of possible layouts, to find the one with the highest score.

In designing a scoring function, it is also helpful to define and/or clarify various factors which contribute to “good” layouts and “bad” layouts. For example, in one embodiment, it is preferable that the score of a layout be based (at least partially) on a function of the average quality of the keywords and ads that it contains. In addition, the scoring function should preferably incorporate other features of the layout, such as the average distance between adjacent keywords, etc.

For page p and highlighted keyword h, and let k(h) be the keyword type of highlight h. Let a* be a vector of ads indexed by keywords appearing on the page, such that a*ₖ is the best ad a ∈ A available for keyword k (this is easily precomputed). Then a layout l ⊂ Hₚ may include a subset of the keyword highlights possible for the page p, using this notation, we propose the following general scoring function:

$$s ( 𝓁 , p , {a}^{*} ) = {\sum }_{h ∈ 𝓁} f ( p , h , {a}_{k ( h )}^{*} ) + {\sum }_{i = 0}^{\vert 𝓁 \vert} g ( d ( {h}_{i} , {h}_{i + 1} ) )$$

Note that ƒ(p, h, a) is the score given to a particular page/highlight/ad combination, d(hᵢ, hᵢ+1) is the distance between adjacent highlights hᵢ and hᵢ+1, and g is a function mapping integer distances (e.g., between adjacent highlights on the page) to real numbers.

According to a specific embodiment, when computing the page/highlight/ad scoring function ƒ it is preferable that the score incorporate both a relevance score as well as an expected monetary value (EMV) estimate. The relevance score can be taken directly from the relevance estimation module, and the EMV score can be computed from the CTR estimate and the cost per click (CPC) of the ad to be displayed:

EMV(p,h,a)=P_{CTR}(c=1|p,h,a)·CPC(a)

In many cases, the relevance and EMV scores may be aligned, but in other cases it may be necessary to sacrifice one to improve the other, and vice-versa. According to specific embodiments, a variety of different techniques may be used to combine them into a single score. Examples of at least some of such techniques are provided below:

Additively, such as, for example:

ƒ(p,h,a)=αEMV(p,h,a)+βRel(p,k,(h),a)

Multiplicatively, such as, for example:

ƒ(p,h,a)=(EMV(p,h,a))^{α}(Rel(p,k(h),a))^{β}

Using Thresholds, such as, for example:

ƒ(p,h,a)=1{EMV(p,h,a)>t}·Rel(p,k(h),a)

ƒ(p,h,a)=EMV(p,h,a)·1{Rel(p,k(h),a)>t}

In the above examples, EMV represents the expected monetary value, and Rel represents the relevance score. The additive and multiplicative options are similar, differing mostly in their behavior near zero. While an additive combination will simply average the two scores, a multiplicative combination will set the score to zero if either the EMV or the relevance score is zero. In at least one embodiment, the multiplicative combination may be preferable, since, for example, it will remove highlights which have a low EMV or low relevance.

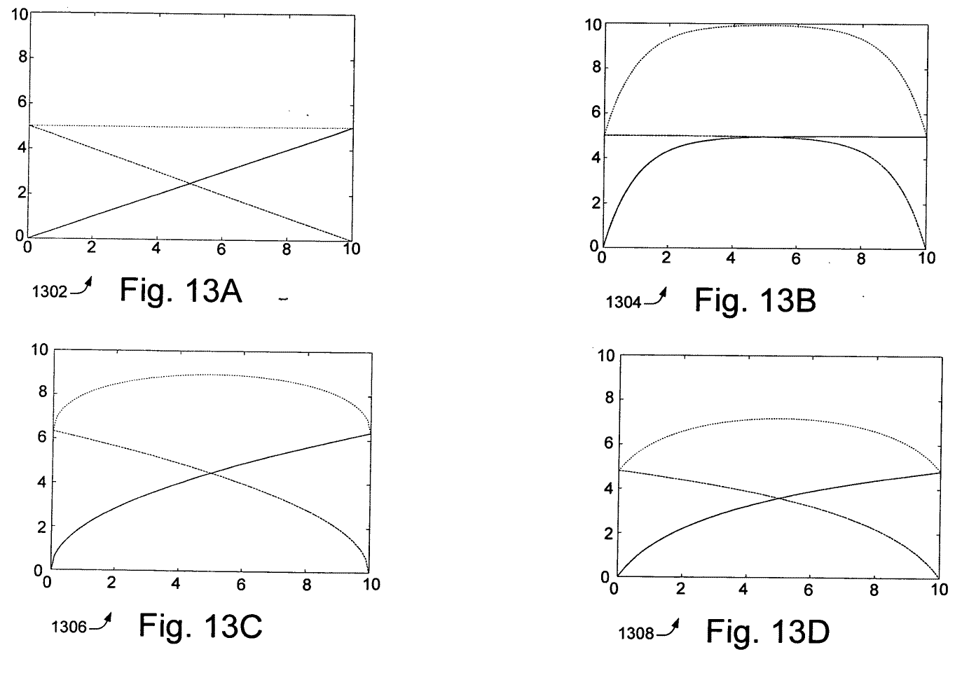

A distance scoring function g may also be used to favor adjacent pairs of highlights that are sufficiently distant from each other. A simple way to do this would be with a linear penalty function which gives a linearly higher score to pairs that are far apart. Unfortunately, a function of this form would not penalize unevenly spaced highlights, as shown, for example, in FIGS. 13A-D.

FIGS. 13A-D depict graphical representations illustrating various behaviors associated with different types of distance scoring functions. For example, FIG. 13A graphically illustrates various behaviors which may be associated with a specific embodiment of a linear scoring function. FIG. 13B graphically illustrates various behaviors which may be associated with a specific embodiment of a negative exponential decay scoring function. FIG. 13C graphically illustrates various behaviors which may be associated with a specific embodiment of a square root scoring function. FIG. 13D graphically illustrates various behaviors which may be associated with a specific embodiment of a logarithmic scoring function. The examples shown in FIGS. 13A-D are intended to illustrate the computation of distance scores for different possible locations of a new highlight (e.g., ContentLink) to be inserted between the two existing highlights located, for example, at 0 and 10, respectively.

According to a specific embodiment, if a sublinear function were used, such as the negative exponential given by:

g(x)=k(1−e^{-x})

the result may be that highlights that are adjacent have a minimum score of 0, and as they spread out (e.g., in distance from each other), their relative score approaches a maximum score of k, as shown, for example, in FIGS. 13A-D.

Yet a third alternative would be a function such as the square root function:

g(x)=k\sqrt{x}

which has a minimum score but no maximum score. That is, the further apart the highlights are, the better.

A fourth alternative would be a shifted log function which continues to grow, but does so very slowly. An example of such a shifted log function is given by:

g(x)=log(x+1)

The space of possible layouts is large: 2^{|Hp}^{|} where Hₚ is the set of possible highlights on a page p. For this reason, the approach of enumerating all possible layouts, scoring them, and returning the highest scoring layout is undesirable. While in principle it may be desirable to search over all combinations of ads on all possible highlights of the page, we can improve efficiency somewhat by searching only over the subsets highlights. For example, various predefined filtering or selection criteria may be used to generate a subset of potential ads and/or highlights for analysis. According to a specific embodiment, for each highlight, we can independently select the best ad to show on that highlight. This removes redundant computation, and makes the search space smaller.

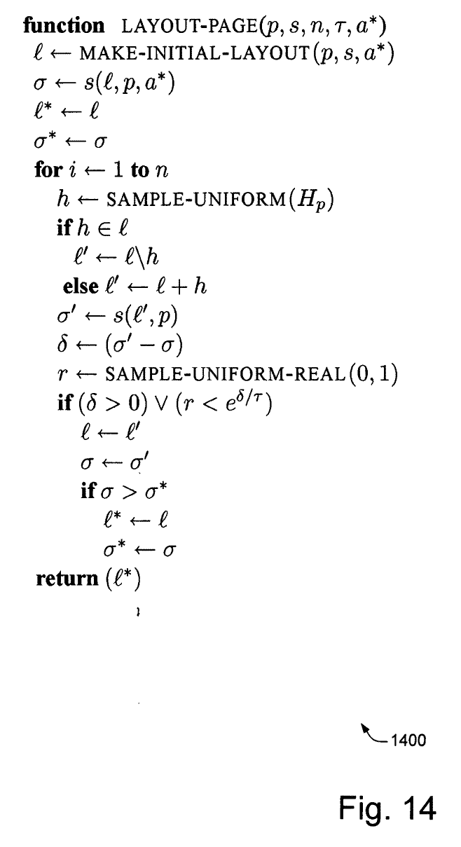

Alternatively, an approximate procedure may be used for finding “good” or “desirable” layouts. For example, according to one embodiment, a stochastic local search algorithm may be used which is based loosely on the well-known simulated annealing approach. Such an algorithm may include the steps of: sampling a new layout, scoring it, and then deciding whether to accept or reject the new layout. Additionally, in at least some embodiments, such an algorithm may be implemented in real-time using dynamic and/or automated processes. New layouts which are determined to be better than the current layout are always accepted. However, at least some new layouts that are determined to be worse than the current layout may be accepted with a small probability which depends on how “bad” they are. The algorithm may also keep track of the best layout seen overall, and returns that, if desired. An example of pseudocode for such a proposed algorithm is illustrated in FIG. 14.

FIG. 14 shows an example of a portion of pseudocode 1400 representing a page layout algorithm which, for example, may be used a for implementing a specific embodiment of a stochastic local search algorithm that may be utilized at the Layout Engine. As shown in example of FIG. 14, variable and/or other parameters relating to the page layout algorithm may include, for example: a page p, a scoring function s giving a real-valued score for each layout l ∈ 2^{Hp} and page p ∈ P, the number of iterations n, a temperature 0<τ, and for each highlight h, the best ad a*ₖ₍ₕ₎ available on the keyword of that highlight. When the temperature τ is large, the system will be very willing to try low scoring layouts, and as τ approaches zero, the system will be unwilling to try layouts that score less than its current layout. A popular variant of this algorithm is to start it with a high value of τ, and slowly decrease τ so that it is close to zero when the algorithm finishes.

According to specific embodiments, relative to the exploration phase (as described, for example, in greater detail below), one may view the Layout Module as implementing at least a portion of the exploitation phase, whereby the ad selection system exploits the current estimates of ad “goodness”, showing the ads it knows are most likely to be successful. In one embodiment, it is preferable for the layout system to interact with the exploitation system in various ways.

For example, one interaction with the exploration system stems from the fact that the Layout Module may need to incorporate some of the lower scoring exploration highlights in the layouts that it selects. Accordingly, in one embodiment, it is preferable that the Layout Module have a parameter x for the maximum number of exploration highlight/ad pairs to include in each layout. The Layout Module may then ask the exploration system for the x highlight/ad pairs that are most valuable to explore.

Once the Layout Module has this set of exploration highlights, there are several ways that the layout system could incorporate them into the final layout. For example, if the number of exploration highlights is very low (e.g., 1), then the layout system could just add them to the good highlights in the existing layout, possibly removing neighboring highlights if they are too close. A more sophisticated way of including them would be to force its inclusion in the layout, and rerun the layout search.

Another interaction with the exploration system stems from the need of the exploration system to assess which ads to explore. To compute the value of information, the exploration system may need to query the exploitation system about the current status of particular highlight/ads. It may need to know whether the ad is currently being shown, and also whether some projected history of counts (e.g., typically a sequence of clicks) would lead the Layout Module to change whether it is including the highlight in the currently layout.

Exploration

In the presence of perfect knowledge of CTRs, one could calculate relevance and layout values, and select ads as described above. However, in many cases at least some of the CTR estimates may be wrong. For example, consider an ad on a new keyword. We will have only very general grounds on which to predict the CTR, perhaps resulting in a low estimate and the keyword not being selected. If, on the other hand, the CTR is actually high, we will not discover this without trying the keyword out. This is an instance of the general tradeoff between exploitation, when we act in the way our estimates suggest, and exploration, when we act in a way which appears suboptimal for the sake of improving our estimates. This concept has been studied in the field of reinforcement learning.

There are again several schemes for incorporating some exploration into the ad selection process. For example, in one embodiment, it is recommended for all (or selected) exploration schemes setting aside a small fixed fraction of the ads on each page (such as, for example, 5-10%) for exploration. In other embodiments, this value may be higher or lower, depending upon desired characteristics. In any event, the amount of exploration may be tuned to reflect contextual ad service provider's (or an individual publisher's) tolerance for early error in exchange for eventual improvement.

One exploration scheme might choose ads for exploration uniformly at random from the ads that are not currently being shown on the page. This strategy would work reasonably well and be simple to implement. It would also provide an opportunity to test the utility of an exploration system. It may be very useful to test empirically whether by doing exploration the system ever discovers new keyword/ad pairs for a page that have high EMV but which were not being discovered using just the existing CTR and Relevance estimates in the exploitation model.

According to specific embodiments, when an exploratory highlight/ad is to be displayed, it may be desirable to choose the ad that maximizes the value of the information that it will provide when we learn whether a user chose to click on it. Intuitively, the display of an ad can provide more valuable information if little is known about it and it has high CPC value. In contrast, there is little value in exploring ads that are known to be “good”, and thus are currently being shown by the exploitation model, and similarly for ads that are known to be “bad”.

In one embodiment, the value of information may be defined as the difference between the expected value of the actions we'd take with and without seeing the exact value of some variable. As applied to the on-line contextual advertising environment, the information we're valuing is whether or not the user clicks on the particular ad the next time (or several times) that it is displayed. The action that this information could influence is whether we choose to show the highlight/ad pair on this page in the future.

For purposes of illustration, let S be the set of possible click streams we could observe over the next n displays if we should choose to explore the highlight/ad pair, and e be our current estimate of the value of the highlight/ad pair. Also let D={0, 1} represent our decision about whether to display the highlight or not in the future. Then the value of the “perfect” information we get from exploring the highlight/ad pair can be written as:

$$VPI ( S ) = [ {\sum }_{s ∈ S} P ( s ) EU ( D \vert s ) ] - EU ( D )$$

where s is the possible click stream, EU(D) is the Utility function of the decision to present certain set of highlights, EU(D|s) is the Utility of a certain set of highlights given a click on s, P(s) is the estimated probability of click (s), and EU(D) is the utility given set of highlights. Using this formula, for example, we can decide whether it is worthwhile exploring and/or exploiting selected data.

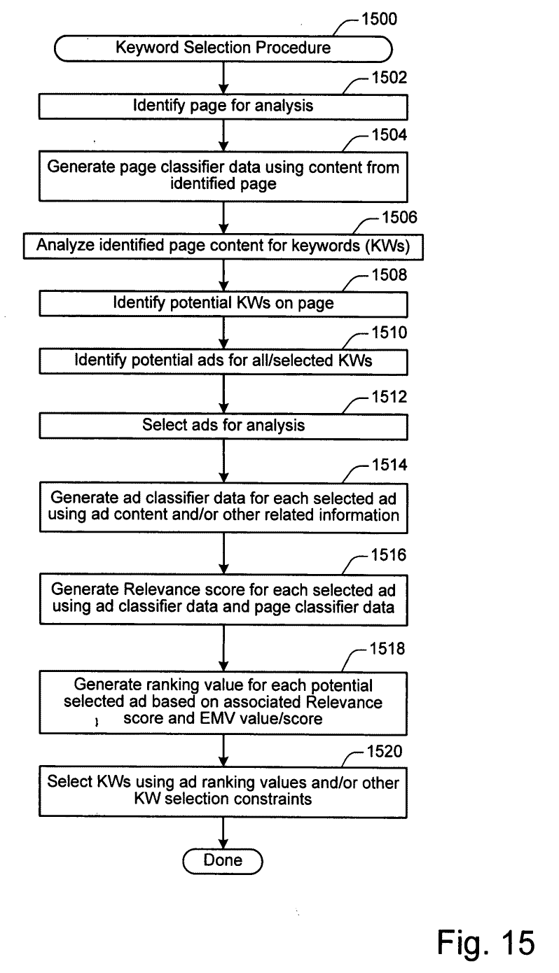

FIG. 15 shows a flow diagram of a Keyword Selection Procedure 1500 in accordance with a specific embodiment. In at least one embodiment, at least some of the features described with respect to FIG. 15 may be implemented by various components of the Kontera Server System.

At 1502 it is assumed that a page (e.g., a web page or other document) is identified for contextual ad analysis.

At 1504, page classifier data may be generated using content from the identified page. In one embodiment the page classifier data may be generated using a text classifier algorithm and/or other techniques for measuring document similarities.

At 1506 the content of the identified page may be analyzed for keywords (KWs), and potential KWs on the page identified (1508) as being a candidate for ad markup/highlighting. In one embodiment, all potential keywords may be identified. Alternatively, a selected set of keywords may be identified based upon specified criteria.

At 1510 potential ads are identified for each (or selected) identified keywords. In one embodiment, all potential ads may be identified for each keyword. Alternatively, a selected set of ads may be identified for each keyword based upon specified criteria. One or more of the identified ads may then be selected (1512) for analysis (e.g., select top five adds for each key word based on CPC estimates).

At 1514, ad classifier data may be generated for each of the selected ads using the ad content and/or other information relating to the ad such as, for example, meta data, content of the ad's landing URL, etc. In one embodiment the ad classifier data may be generated using a text classifier algorithm and/or other techniques for measuring document similarities.

At 1516, a relevance score may be generated for each of the selected ads. In one embodiment, the relevance score may be used to indicate the degree of relevance between a given ad and the content of the identified page. In one embodiment, ad relevance analysis may be performed for each selected ad, for example, by analyzing the ad content (e.g. text), associated meta data, and/or content of the ad's associated landing URL, and comparing the analyzed information to the content (or other characteristics) of the identified page. In at least some embodiments, some ads may not require relevance to be selected. For example, some advertisers may specify that specific ads be used for specified keywords/URLs.

At 1518, a ranking value for each selected ad may be generated based, for example, on the ad's associated relevance score and associated EVM score/value.

At 1520, specific keywords may be selected for markup/highlighting using the ad ranking values and/or other keyword selection constraints. According to specific embodiments, such constrains may include, for example, one or more of the following:
Keywords restrictions.
Sensitivity restrictions (e.g., words not suitable for children).
ContentLinks limit per page and paragraph.
Minimum distance between ContentLinks.
Do not highlight ContentLinks below a certain threshold to avoid cannibalization.
Some publishers only allow Contextual ContentLinks.
Some publishers may only get direct ContentLinks (approval type).
Minimum CPC restrictions.

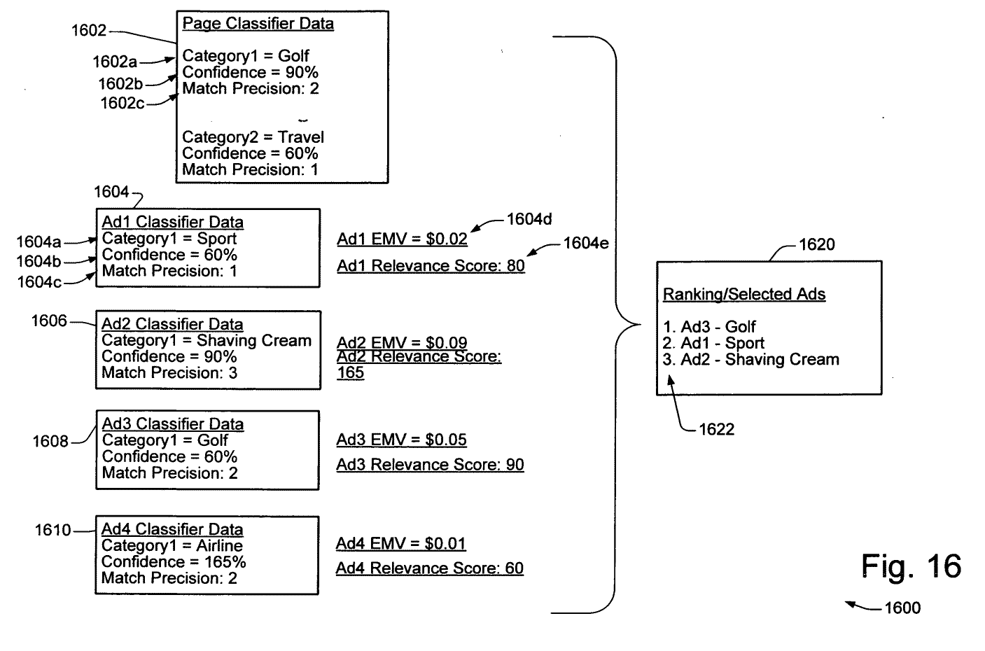

FIG. 16 provides a specific example of various criteria which may be used and/or generated during embodiment of the Keyword Selection Procedure 1500 and FIG. 15. In this particular example, it is assumed that a specific web page 1602 has been identified for analysis, and that page classifier data has been generated for the selected web page. In this particular example, the web page has been classified as being related to two different categories: Golf and Travel. In one embodiment, the page classifier data may include a confidence indicator/parameter (e.g., 1602b) for conveying a confidence level that the identified web page relates to the identified category (e.g., 1602a). For example, as shown in FIG. 16, the page classifier algorithm has indicated a confidence parameter of 90% that the content of the identified web page relates to the category of Golf. Additionally, as shown in FIG. 16, the page classifier data may include a Match Precision indicator (e.g., 1602c) which relates to how specific/precise the identified category (1602a) is with respect to a category hierarchy. For example, in one embodiment, the lower the value of the Match Precision indicator, the more general the associated category value. Thus, for example, the general category of “Sports” may have an associated category value of 1, whereas a subcategory of “Sports” such as “Golf” may have an associated category value of 2.

Additionally, as shown in the example of FIG. 16, it is assumed that a plurality of ads (e.g., 1604, 1606, 1608, 1610) had been identified for analysis. In one embodiment, the Keyword Selection Procedure 600 may be used to generate, for each of the identified ads, one or more of the following: ad classifier data (e.g., 1604a-c), ad EVM data (e.g., 1604d), ad relevance data (e.g., 1604e), etc.

In one embodiment, the estimated EMV value for a given ad may be calculated according to: EMV(Ad)=CTR(Ad)*CPC(Ad)

In at least one embodiment, the Keyword Selection Procedure 1500 may also be used to use the various information illustrated in FIG. 16 to determine a ranking (e.g. 1622) of the most desirable ads to be selected for the identified web page. Once the appropriate ads have been selected, specific keywords may be selected for markup/highlighting using the ad ranking values and/or other keyword selection constraints.

Other Benefits/Features

Listed below are examples of other benefits, features and/or advantages of the present invention which may be implemented in one or more specific embodiments:

At least one embodiment may be adapted to automatically identify and/or select appropriate keywords to be associated with specific links based on one or more predetermined sets of parameters. Such embodiment obviate the need for one to manually select such keywords.

At least one embodiment may be adapted to analyze many different pages on a given web site or network of sites, determine the best matching topic for each page, and/or mark relevant keywords to thereby link pages of related topics. In this way, a relationship is formed between the topic that the user is currently reading and the page that the related link will lead to.

At least one embodiment may be implemented in a manner such that, when a user clicks on a word or phrase of a particular web page, results may be displayed to the user which includes information relating not only to the selected word/phrase, but also relating to the context of the entire web page. Additionally, in one embodiment, the related information may be determined and displayed to the user without performing a query to one or more search engines for the selected word/phrase.

According to a specific embodiment, when a user views the web page in his browser, and places his mouse over the hyperlink, a layer pops up near the link containing a textual advertisement. If either the hyperlink or the advertisement are clicked on, the user's browser is directed to a new page designated by the advertiser.

### Other Embodiments

Generally, the contextual information delivery techniques described herein may be implemented in software and/or hardware. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

A software or software/hardware hybrid embodiment of the contextual information delivery technique of this invention may be implemented on a general-purpose programmable machine selectively activated or reconfigured by a computer program stored in memory. Such programmable machine may be a network device designed to handle network traffic, such as, for example, a router or a switch. Such network devices may have multiple network interfaces including frame relay and ISDN interfaces, for example. Specific examples of such network devices include routers and switches. A general architecture for some of these machines will appear from the description given below. In an alternative embodiment, the contextual information delivery technique of this invention may be implemented on a general-purpose network host machine such as a personal computer or workstation. Further, the invention may be at least partially implemented on a card (e.g., an interface card) for a network device or a general-purpose computing device.

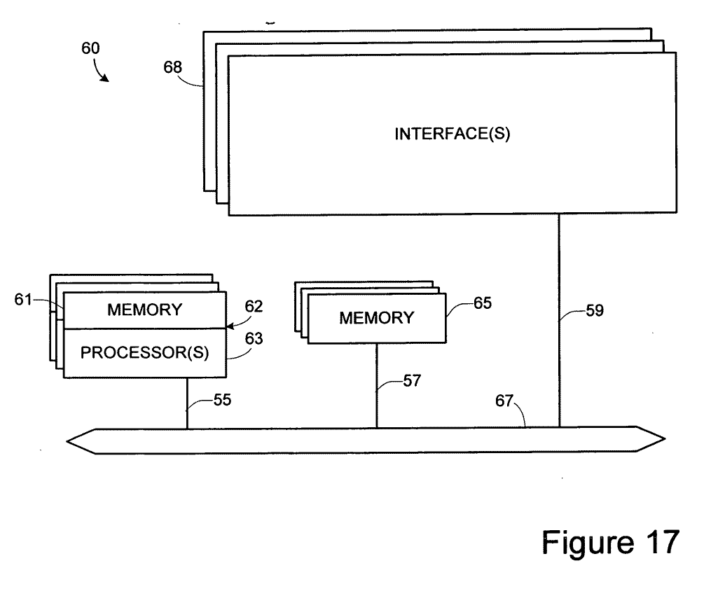

Referring now to FIG. 17, a network device 60 suitable for implementing various techniques and/or features described herein may include a master central processing unit (CPU) 62, interfaces 68, and a bus 67 (e.g., a PCI bus). When acting under the control of appropriate software or firmware, the CPU 62 may be responsible for implementing specific functions associated with the functions of a desired network device. For example, when configured as a network server, the CPU 62 may be responsible for analyzing packets, encapsulating packets, forwarding packets to appropriate network devices, analyzing web page content, generating web page modification instructions, etc. The CPU 62 preferably accomplishes all these functions under the control of software including an operating system (e.g. Windows NT), and any appropriate applications software.

CPU 62 may include one or more processors 63 such as a processor from the Motorola or Intel family of microprocessors or the MIPS family of microprocessors. In an alternative embodiment, processor 63 is specially designed hardware for controlling the operations of network device 60. In a specific embodiment, a memory 61 (such as non-volatile RAM and/or ROM) also forms part of CPU 62. However, there are many different ways in which memory could be coupled to the system. Memory block 61 may be used for a variety of purposes such as, for example, caching and/or storing data, programming instructions, etc.

The interfaces 68 are typically provided as interface cards (sometimes referred to as “line cards”). Generally, they control the sending and receiving of data packets over the network and sometimes support other peripherals used with the network device 60. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 62 to efficiently perform routing computations, network diagnostics, security functions, etc.

Although the system shown in FIG. 17 illustrates a specific embodiment of a network device, it is by no means the only network device architecture on which the various techniques of the present invention may be implemented. For example, an architecture having a single processor that handles communications as well as routing computations, etc. is often used. Further, other types of interfaces and media could also be used with the network device.

Regardless of network device's configuration, it may employ one or more memories or memory modules (such as, for example, memory block 65) configured to store data, program instructions for the general-purpose network operations and/or other information relating to the functionality of the contextual information delivery techniques described herein. The program instructions may control the operation of an operating system and/or one or more applications, for example. The memory or memories may also be configured to store data structures, keyword taxonomy information, advertisement information, user click and impression information, and/or other specific non-program information described herein.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher level code that may be executed by the computer using an interpreter.

It will be appreciated that, in at least one embodiment, this method will interact with decaying counts such that all ads will eventually be reconsidered as their negative evidence decays sufficiently. This prevents the system from “dooming” an ad to perpetual obscurity just because it performed poorly at some point.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

It is claimed:

1. A system for facilitating on-line contextual advertising operations implemented in a computer network, the system comprising:
an estimation engine adapted to generate EMV information relating to estimates of Expected Monitory Values (EMV) based on specified criteria, said specified criteria including click through rate (CTR) estimation information;
a relevance engine adapted to generate relevance information relating to relevance criteria between a specified page or document and at least one specified ad;
a layout engine adapted to generate ad ranking information for one or more of the at least one specified ads using the relevance information and EMV information;
a data analysis engine adapted to analyze historical information including user behavior information and advertising-related information; and
an exploration engine adapted to explore the use of selected keywords and ads in order for the purpose of improving EMV estimation.

2. A method for facilitating on-line contextual advertising operations implemented in a computer network, the method comprising:
identifying a first page for contextual ad analysis;
generating page classifier data using content associated with the first page;
identifying a first group of keywords on the page as being candidates for ad markup/highlighting;
identifying one or more potential ads for selected keywords of the first group of keywords;
generating ad classifier data for each of the identified ads using at least one criteria selected from a group consisting of: ad content, meta data, and content of the ad's landing URL;
generating a relevance score for each of the selected ads, wherein the relevance score indicates the degree of relevance between a given ad and the content of the identified page;
generating a ranking value for each selected ad based on the ad's associated relevance score and associated EVM estimate; and
selecting specific keywords for markup/highlighting using at least the ad ranking values.

3. A system for facilitating on-line contextual advertising operations implemented in a computer network, the system comprising:
means for identifying a first page for contextual ad analysis;
means for generating page classifier data using content associated with the first page;
means for identifying a first group of keywords on the page as being candidates for ad markup/highlighting;
means for identifying one or more potential ads for selected keywords of the first group of keywords;
means for generating ad classifier data for each of the identified ads using at least one criteria selected from a group consisting of: ad content, meta data, and content of the ad's landing URL;
means for generating a relevance score for each of the selected ads, wherein the relevance score indicates the degree of relevance between a given ad and the content of the identified page;
means for generating a ranking value for each selected ad based on the ad's associated relevance score and associated EVM estimate; and
means for selecting specific keywords for markup/highlighting using at least the ad ranking values.
